(19) United States
(12) Patent Application Publication
(10) Pub. No.: US 2024/0179713 A1
(43) Pub. Date: May 30, 2024

(54) UPLINK CONTROL INFORMATION TRANSMISSION METHOD AND APPARATUS, AND RELATED DEVICE

(71) Applicant: VIVO MOBILE COMMUNICATION CO., LTD., Chang'an (CN)

(72) Inventors: Chaojun ZENG, Chang'an (CN); Lihui WANG, Chang'an (CN)

(73) Assignee: VIVO MOBILE COMMUNICATION CO., LTD., Chang'an (CN)

(21) Appl. No.: 18/432,188

(22) Filed: Feb. 5, 2024

Related U.S. Application Data
(63) Continuation of application No. PCT/CN2022/109730, filed on Aug. 2, 2022.

(30) Foreign Application Priority Data
Aug. 6, 2021 (CN) 202110904397.7

(51) Int. Cl. H04W 72/21; H04L 1/1812; H04W 72/11; H04W 72/12; H04W 72/232

(52) U.S. Cl. CPC H04W 72/21; H04L 1/1812; H04W 72/11; H04W 72/12; H04W 72/232

(57) ABSTRACT

This application discloses an uplink control information transmission method and apparatus, and a related device. The method includes: determining, by a terminal based on at least two pieces of uplink control information (UCI), at least one physical uplink control channel (PUCCH) cell corresponding to the at least two pieces of UCI; and transmitting, by the terminal, first target UCI on a target PUCCH cell among the at least one PUCCH cell, where the first target UCI is determined based on the at least two pieces of UCI.

### CROSS-REFERENCE TO RELATED APPLICATIONS

This application is a Bypass Continuation application of PCT International Application No. PCT/CN2022/109730 filed on Aug. 2, 2022, which claims priority to Chinese Patent Application No. 202110904397.7, filed on Aug. 6, 2021 in China, which is incorporated herein by reference in its entirety.

### TECHNICAL FIELD

This application relates to the field of communications technologies, and in particular, to an uplink control information transmission method and apparatus, and a related device.

### BACKGROUND

As for physical uplink control channel (PUCCH) carrier switching, when a dynamic indication manner is used, the current discussion mainly focuses on hybrid automatic repeat request acknowledgement (HARQ-ACK) feedback, and other information types of uplink control information (UCI) are less mentioned. When PUCCH carrier switching is applied for the HARQ-ACK feedback and involves transmission of other UCI information types, currently, there is no corresponding solution to a multiplexing operation among UCI information types, which leads to limited transmission or poor transmission performance when UCI with different information types is transmitted.

### SUMMARY

Embodiments of this application provide an uplink control information transmission method and apparatus, and a related device.

According to a first aspect, an uplink control information transmission method is provided, including:
determining, by a terminal based on at least two pieces of uplink control information (UCI), at least one physical uplink control channel (PUCCH) cell corresponding to the at least two pieces of UCI; and
transmitting, by the terminal, first target UCI on a target PUCCH cell among the at least one PUCCH cell, where the first target UCI is determined based on the at least two pieces of UCI.

According to a second aspect, an uplink control information transmission method is provided, including:
receiving, by a network side device, first target UCI transmitted by a terminal through a target physical uplink control channel (PUCCH) cell, where
the target PUCCH cell is a cell in at least one PUCCH cell, the at least one PUCCH cell is determined based on at least two pieces of uplink control information (UCI), and the first target UCI is determined based on the at least two pieces of UCI.

According to a third aspect, an uplink control information transmission apparatus is provided, including:
a determining module, configured to determine, based on at least two pieces of uplink control information (UCI), at least one physical uplink control channel (PUCCH) cell corresponding to the at least two pieces of UCI; and
a transmitting module, configured to transmit first target UCI on a target PUCCH cell among the at least one PUCCH cell, where the first target UCI is determined based on the at least two pieces of UCI.

According to a fourth aspect, an uplink control information transmission apparatus is provided, including:
a receiving module, configured to receive first target UCI transmitted by a terminal through a target physical uplink control channel (PUCCH) cell, where
the target PUCCH cell is a cell in at least one PUCCH cell, the at least one PUCCH cell is determined based on at least two pieces of uplink control information (UCI), and the first target UCI is determined based on the at least two pieces of UCI.

According to a fifth aspect, a terminal is provided, where the terminal includes a processor, a memory, and a program or an instruction stored in the memory and executable on the processor, and when the program or the instruction is executed by the processor, steps of the uplink control information transmission method according to the first aspect are implemented.

According to a sixth aspect, a network side device is provided, where the network side device includes a processor, a memory, and a program or an instruction stored in the memory and executable on the processor, and when the program or the instruction is executed by the processor, steps of the uplink control information transmission method according to the second aspect are implemented.

According to a seventh aspect, a readable storage medium is provided, where the readable storage medium stores a program or an instruction, and when the program or the instruction is executed by a processor, steps of the uplink control information transmission method according to the first aspect or the second aspect are implemented.

According to an eighth aspect, a chip is provided, where the chip includes a processor and a communications interface, the communications interface is coupled to the processor, and the processor is configured to run a program or an instruction of a network side device, to implement the uplink control information transmission method according to the first aspect or the second method.

### BRIEF DESCRIPTION OF DRAWINGS

FIG. 1 is a structural diagram of a network system according to an embodiment of this application;

FIG. 2 is a flowchart of an uplink control information transmission method according to an embodiment of this application;

FIG. 3a to FIG. 3c are flowcharts of a fusion information obtaining process according to an embodiment of this application;

FIG. 4 is another flowchart of an uplink control information transmission method according to an embodiment of this application;

FIG. 5 is a structural diagram of an uplink control information transmission apparatus according to an embodiment of this application;

FIG. 6 is another structural diagram of an uplink control information transmission apparatus according to an embodiment of this application;

FIG. 7 is a structural diagram of a communications device according to an embodiment of this application;

FIG. 8 is a structural diagram of a terminal according to an embodiment of this application; and

FIG. 9 is a structural diagram of a network side device according to an embodiment of this application.

### DESCRIPTION OF EMBODIMENTS

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, data termed in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and a character “/” generally represents an “or” relationship between associated objects. In this application, “transmission” means signal transfer, not signal sending in a narrow sense.

It should be noted that, the technologies described in the embodiments of this application are not limited to a Long Term Evolution (LTE)/LTE-Advanced (LTE-A) system, and can also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. However, a new radio (NR) system is described in the following description for an illustration purpose, and NR terms are used in most of the following descriptions, although these technologies may also be applied to other applications than an NR system application, such as a 6^{th} generation (6G) communications system.

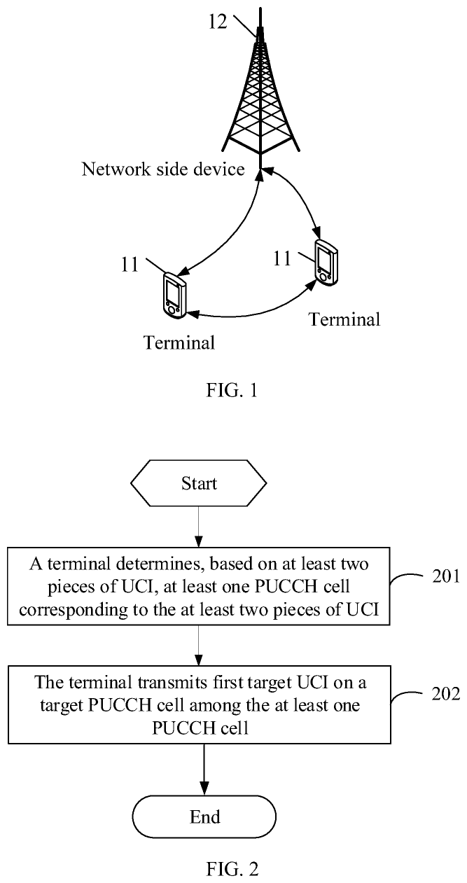

FIG. 1 is a structural diagram of a wireless communications system to which embodiments of this application can be applied. The wireless communications system includes a terminal 11 and a network side device 12. The terminal 11 may also be referred to as a terminal device or user equipment (UE). The terminal 11 may be a terminal side device such as a mobile phone, a tablet computer, a laptop computer or a notebook computer, a personal digital assistant (Personal Digital Assistant, PDA), a palmtop computer, a netbook, an ultra-mobile personal computer (UMPC), a mobile Internet device (MID), a wearable device, vehicle user equipment (VUE), or pedestrian user equipment (PUE). The wearable device includes a bracelet, a headset, glasses, and the like. It should be noted that a specific type of the terminal 11 is not limited in the embodiments of this application. The network side device 12 may be a base station or a core network. The base station may be referred to as a NodeB, an evolved NodeB, an access point, a base transceiver station (BTS), a radio base station, a radio transceiver, a basic service set (BSS), an extended service set (ESS), a NodeB, an evolved NodeB (eNB), a home NodeB, a home evolved NodeB, a wireless local area network (WLAN) access point, a wireless fidelity (Wi-Fi) node, a transmitting receiving point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

With reference to the accompanying drawings, an uplink control information transmission method provided in the embodiments of this application is described in detail by using specific embodiments and application scenarios thereof.

Referring to FIG. 2, FIG. 2 is a flowchart of an uplink control information transmission method, and the uplink control information transmission method includes the following steps.

Step 201. A terminal determines, based on at least two pieces of uplink control information (UCI), at least one physical uplink control channel (PUCCH) cell corresponding to the at least two pieces of UCI.

The at least two pieces of UCI may include two or more pieces of UCI. The terminal determines a PUCCH cell for transmitting each piece of UCI based on each piece of UCI.

Step 202. The terminal transmits first target UCI on a target PUCCH cell among the at least one PUCCH cell, where the first target UCI is determined based on the at least two pieces of UCI.

After determining the at least one PUCCH cell, the terminal selects the target PUCCH cell from the at least one PUCCH cell to transmit the first target UCI. The first target UCI is determined based on the at least two pieces of UCI. For example, the first target UCI may include a part of or all of UCI among the at least two pieces of UCI.

In this embodiment, the terminal determines, based on the at least two pieces of uplink control information (UCI), at least one PUCCH cell corresponding to the at least two pieces of UCI. The terminal transmits the first target UCI on the target PUCCH cell among the at least one PUCCH cell, where the first target UCI is determined based on the at least two pieces of UCI. Transmitting the first target UCI on the target PUCCH cell can improve transmission performance of the at least two pieces of UCI.

In the foregoing description, the UCI includes at least one of the following:
a hybrid automatic repeat request acknowledgement (HARQ-ACK);
a scheduling request (SR); and
channel state information (CSI).

It can also be understood as that the information type of UCI includes at least one of HARQ-ACK, SR, and CSI. For example, if UCI1 includes HARQ-ACK1 and SR1, and UCK includes HARQ-ACK2, then both UCI1 and UCI2 include the information type of HARQ-ACK.

For the type of HARQ-ACK, at least one of a dynamic scheduling HARQ-ACK and a semi-persistent scheduling (SPS) HARQ-ACK may be included. The dynamic scheduling HARQ-ACK includes an HARQ-ACK corresponding to Fallback downlink control information (DCI) and an HARQ-ACK corresponding to Non-fallback DCI. As for the HARQ-ACK corresponding to the Fallback DCI, for example, HARQ-ACK feedback corresponding to SPS release transmitted on or indicated by a physical downlink shared channel (PDSCH) scheduled in DCI format 1_0. As for the HARQ-ACK corresponding to the Non-fallback DCI, for example, HARQ-ACK feedback corresponding to SPS release transmitted on or indicated by a PDSCH scheduled in DCI format 1_1 or DCI format 1_2.

The SR type may include at least one of an SR and a link recovery request (LRR).

The channel state information (CSI) type may include at least one of periodic CSI, semi-persistent CSI, and aperiodic CSI.

For each of the at least two pieces of UCI, the UCI information type included in the UCI may include at least one of HARQ-ACK, SR, and CSI. Different pieces of UCI may include different types of UCI information.

The UCI information type included in the UCI may be used in determining at least one PUCCH cell based on the at least two pieces of UCI. For example, a PUCCH cell corresponding to a specific UCI information type can be understood as a PUCCH cell where a corresponding PUCCH resource/transmission is located when such UCI information is transmitted separately.

The PUCCH cell corresponding to each UCI information type is determined as follows.

HARQ-ACK type: as for the dynamic scheduling HARQ-ACK, when the Non-fallback DCI is used, the dynamic scheduling DCI can indicate the PUCCH cell corresponding to the dynamic scheduling HARQ-ACK; and when the Fallback DCI is used, if a corresponding dynamic scheduling HARQ-ACK and the dynamic scheduling HARQ-ACK corresponding to the Non-fallback DCI are multiplexed (that is, included in a same HARQ-ACK codebook for transmission), a PUCCH cell indicated by a specific piece of Non-fallback DCI can be used (it can be further assumed that one or more pieces of Non-fallback DCI corresponding to this HARQ-ACK codebook typically indicate a same PUCCH cell, then one of the above pieces of Non-fallback DCI can be any Non-fallback DCI in the one or more pieces of Non-fallback DCI; and optionally, when the one or more pieces of Non-fallback DCI indicate different PUCCH cells, a PUCCH cell indicated by a last piece of Non-fallback DCI is used, that is, the HARQ-ACK codebook is transmitted on the PUCCH cell indicated by the last piece of Non-fallback DCI). When the corresponding dynamic scheduling HARQ-ACK and the dynamic scheduling HARQ-ACK corresponding to the Non-fallback DCI are not multiplexed (that is, all pieces of DCI corresponding to an HARQ-ACK codebook corresponding to a specific piece of Fallback DCI are the Fallback DCI), the PUCCH cell corresponding to the corresponding dynamic scheduling HARQ-ACK (or an HARQ-ACK codebook thereof) can be determined in an SPS HARQ-ACK carrier manner 2 described below.

As for the SPS HARQ-ACK, a corresponding PUCCH cell can be determined in any of the following manners.

SPS HARQ-ACK carrier manner 1: being dynamically indicated by SPS activation/reactivation DCI.

SPS HARQ-ACK carrier manner 2: being fed back on a fixed PUCCH cell, such as a PCell/PSCell/PUCCH SCell, which can be specified in a protocol or configured based on higher layer signaling.

When the SPS HARQ-ACK is multiplexed with another SPS HARQ-ACK or dynamic scheduling HARQ-ACK, a PUCCH cell corresponding to a multiplexed HARQ-ACK bit sequence can be selected/determined according to a predefined rule.

SR type: when an SR corresponding to a specific SR configuration (Config) is triggered, a PUCCH cell corresponding to PUCCH transmission corresponding to a specific scheduling request resource configuration (scheduling request resource configuration) associated with this SR configuration, that is, a PUCCH cell of (or corresponding to) the PUCCH Config where this scheduling request resource configuration is located (that is, the PUCCH configuration is configured in an uplink (UL) bandwidth part (BWP) of a serving cell corresponding to the PUCCH cell).

CSI type: a PUCCH cell corresponding to CSI reporting is a PUCCH cell where a CSI reporting configuration (Report Config) corresponding to periodic CSI or semi-persistent CSI on PUCCH is located (that is, this CSI reporting configuration is configured in a serving cell (Serving cell) corresponding to this PUCCH cell).

That is, the at least one PUCCH cell corresponding to the at least two pieces of UCI can be determined in the following manners:
in a case that the at least two pieces of UCI include a first dynamic scheduling HARQ-ACK, the at least one PUCCH cell includes a PUCCH cell corresponding to the first dynamic scheduling HARQ-ACK, and the first dynamic scheduling HARQ-ACK is indicated by a first type of DCI;
in a case that the at least two pieces of UCI include a second dynamic scheduling HARQ-ACK and at least one third dynamic scheduling HARQ-ACK, the at least one PUCCH cell includes a PUCCH cell corresponding to the third dynamic scheduling HARQ-ACK, the second dynamic scheduling HARQ-ACK is indicated by a second type of DCI, the third dynamic scheduling HARQ-ACK is indicated by the first type of DCI, and the second dynamic scheduling HARQ-ACK and the at least one third dynamic scheduling HARQ-ACK are transmitted in a same HARQ-ACK codebook;
in a case that the at least two pieces of UCI include semi-persistent scheduling (SPS) HARQ-ACK, or the at least two pieces of UCI include a dynamic scheduling HARQ-ACK indicated by the second type of DCI, and the dynamic scheduling HARQ-ACK indicated by the second type of DCI is not transmitted, in a same HARQ-ACK codebook, with any dynamic scheduling HARQ-ACK indicated by the first type of DCI, the at least one PUCCH cell includes a PUCCH cell configured according to a protocol or based on higher layer signaling;
in a case that the at least two pieces of UCI include SPS HARQ-ACK, the at least one PUCCH cell includes a PUCCH cell dynamically indicated by SPS activation or reactivation DCI;
in a case that the at least two pieces of UCI include an SR corresponding to one SR configuration, the at least one PUCCH cell includes a PUCCH cell corresponding to first PUCCH transmission, where the first PUCCH transmission is PUCCH transmission corresponding to a scheduling request resource configuration associated with one SR configuration;
in a case that the at least two pieces of UCI include periodic CSI, the at least one PUCCH cell includes a PUCCH cell configured with a first CSI reporting configuration, where the first CSI reporting configuration is a CSI reporting configuration corresponding to the periodic CSI carried on PUCCH; and
in a case that the at least two pieces of UCI include semi-persistent CSI, the at least one PUCCH cell includes a PUCCH cell configured with a second CSI reporting configuration, where the second CSI reporting configuration is a CSI reporting configuration corresponding to the semi-persistent CSI carried on PUCCH.

In the foregoing description, in the first type of DCI, an indicator field can explicitly indicate a PUCCH cell corresponding to a corresponding dynamic scheduling HARQ-ACK (that is, a PUCCH cell carrying this dynamic scheduling HARQ-ACK), such as the Non-fallback DCI.

In the second type of DCI, there is no indicator field for explicitly indicating a PUCCH cell corresponding to a corresponding dynamic scheduling HARQ-ACK (that is, a PUCCH cell carrying this dynamic scheduling HARQ-ACK), such as the Fallback DCI.

As for a specific PUCCH cell group configured for UE, it is assumed that there is at least one serving cell that can be used to transmit the PUCCH to feed back the HARQ-ACK, which can be referred to as the PUCCH cell.

The following describes various situations of UCI transmission.

In a first case, only the HARQ-ACK type is transmitted. As for the dynamic scheduling HARQ-ACK, at a specific moment (for example, in a specific slot or sub-slot), at most, only a single PUCCH cell is used to transmit a codebook corresponding to the dynamic scheduling HARQ-ACK.

As for the Non-fallback DCI, the single PUCCH cell can be directly indicated by DCI, so when indicating or understanding K1, refer to K1 Set configured/used for the single PUCCH cell (for example, PUCCH-Config->dl-DataToUL-ACK parameter).

For the Fallback DCI, the single PUCCH cell can be determined based on the SPS HARQ-ACK carrier manner 2 when it is not multiplexed with the HARQ-ACK corresponding to the Non-fallback DCI, and can be determined based on the PUCCH cell indicated by the Non-fallback DCI when it is multiplexed. For K1 Set used, a preset regulation can still be used, such as {1, 2, 3, 4, 5, 6, 7, 8}.

In order to avoid missed detection of DCI and the influence of different K1 sets due to different PUCCH cell configurations or applications, it may be required that PUCCH cells indicated in the dynamic scheduling DCI (which can be understood as Non-fallback DCI) pointing to the same time (for example, pointing to the same Slot/Sub-slot) are consistent. As for the Fallback DCI, in order to avoid the change of the corresponding PUCCH cell (and the change of the time-domain feedback position occurred when the subcarrier spacings (SCS)/numerologies corresponding to the PUCCH cell are different), it can be handled/solved by the network based on implementation. For example, for a specific HARQ-ACK codebook, one or more pieces of Non-Fallback DCI are used to determine a corresponding PUCCH cell, and then the Fallback DCI is used to indicate the HARQ-ACK that needs to be further multiplexed on this HARQ-ACK codebook as required, or the Fallback DCI is used for all scheduling (in this case, the corresponding PUCCH cell does not depend on the indication of the Non-fallback DCI).

As for the SPS HARQ-ACK, when multiplexing does not occur, the SPS HARQ-ACK can be transmitted on a corresponding PUCCH cell.

When the SPS HARQ-ACK is multiplexed with another SPS HARQ-ACK or dynamic scheduling HARQ-ACK, a PUCCH cell corresponding to a multiplexed HARQ-ACK bit sequence can be selected/determined according to a predefined rule.

In a second case, multiplexing between two or more UCI information types (including or not including HARQ-ACK).

When PUCCH resources carrying different UCI information types are on the same PUCCH cell or different PUCCH cells and there is time domain overlapping, multiplexing among these UCI information types can be considered. It should be noted that these PUCCH resources may be located in different PUCCH cells, and corresponding subcarrier spacings (SCS) or numerologies may also be different. Time domain overlapping can be determined based on absolute time, that is, whether there is time domain overlapping between two PUCCH resources (or transmission), or determined based on whether there is overlapping between corresponding time periods of these two PUCCH resources (or transmission). When the time periods overlap, it can be determined that there is time domain overlapping. The determining time domain overlapping based on the absolute time can be applied to determining time domain overlapping between PUCCH resources located in different PUCCH cells, and can also be applied to determining time domain overlapping between PUCCH resources located in a same PUCCH cell.

When the multiplexing between different UCI information types involves HARQ-ACK information, whether and how to multiplex with other types of UCI information can be further considered after determining the HARQ-ACK (including the HARQ-ACK codebook/bit sequence that needs to be transmitted and the corresponding PUCCH cell, the PUCCH resources, and the like).

When PUCCH resources (each corresponds to different pieces of UCI information or UCI information types) that need to be multiplexed based on time domain overlapping are all located in (or corresponding to) a same PUCCH cell, a preset rule, such as a first preset rule, is used to determine the transmission manner.

When at least one PUCCH resource among PUCCH resources (each corresponds to different pieces of UCI information or UCI information types) that need to be multiplexed based on time domain overlapping is located in (or corresponding to) different PUCCH cells, any one of the following manners can be used.

Only a single PUCCH cell is used for transmission at most at the same time, or a plurality of PUCCH cells are used for transmission in parallel.

The above two manners will be described below.

In a first manner, only a single PUCCH cell is used for transmission at most at the same time. In this case, the transmitting, by the terminal, first target UCI on a target PUCCH cell among the at least one PUCCH cell includes:
transmitting, by the terminal, the first target UCI on a target PUCCH cell among the at least two PUCCH cells, where the target PUCCH cell is one of the at least two PUCCH cells, and the first target UCI is determined based on the at least two pieces of UCI. Overlapping in time domain exists among PUCCH resources carrying the at least two pieces of UCI, and the PUCCH resources carrying the at least two pieces of UCI are located in at least two PUCCH cells.

In a case, the first target UCI is determined according to a first preset rule based on the at least two pieces of UCI, and an attribute and a time domain overlapping situation of a PUCCH resource corresponding to each of the at least two pieces of UCI; and the target PUCCH cell is a PUCCH cell corresponding to a PUCCH resource carrying the first target UCI.

Two or more PUCCH resources (or transmission) overlapping in time domain and carrying UCI separately can be located on different PUCCH cells of a same PUCCH cell group, as long as a time domain overlapping condition is met. After determining which PUCCH resource to use and which UCI to transmit according to the first preset rule, the finally determined PUCCH resource can be directly used for corresponding PUCCH transmission in a corresponding PUCCH cell and within a slot/sub-slot.

The first preset rule is described below by using an example.

There are a plurality of cases as follows.

Case 1: HARQ-ACK and SR, or CSI and SR are multiplexed in PUCCH.

Specifically, in a case of a single Positive/Negative SR (a PUCCH format is not limited) and Format0 HARQ-ACK (N<=2), the HARQ-ACK is fed back on Format0 HARQ-ACK resource: in a case of Positive SR, CS (Cyclic Shift) is adjusted, otherwise (in a case of Negative SR), CS is not adjusted.

In a case of Format0 Positive/Negative SR and Format1 HARQ-ACK (N<=2), the HARQ-ACK is transmitted on the Format1 HARQ-ACK resource as normal, and SR is ignored.

In a case of Format1 Positive/Negative SR and Format1 HARQ-ACK (N<=2), in a case of Positive SR, the HARQ-ACK is fed back on the SR resource, otherwise (in a case of Negative SR), the HARQ-ACK is fed back on the HARQ-ACK resource.

In a case of Format2/3/4 HARQ-ACK and K SR resources, the SR indication bit is attached to the end of the HARQ-ACK bit, and the dynamic scheduling HARQ-ACK PUCCH resource indicated by Last DCI is used.

In a case of Format2/3/4 CSI and K SR resources, the SR indication bit is before the CSI bit, and the PUCCH resource reported by CSI is used.

Case 2: HARQ-ACK, SR, and CSI are multiplexed in PUCCH.

If there is no HARQ-ACK, or only SPS HARQ-ACK (1 bit), and CSI (wideband or subband report) is transmitted, then transmission is multiplexed on a CSI PUCCH resource.

There is an HARQ-ACK for DCI response (that is, there is a dynamic scheduling HARQ-ACK), and transmission is multiplexed on the HARQ-ACK PUCCH resource indicated by Last DCI.

Case 3: Two kinds of physical layer priorities can be optionally configured. For each UCI information type and each PUCCH/PUSCH transmission, the corresponding physical layer priority can be specified, configured, or dynamically indicated, and CSI reporting is a fixed lower physical layer priority.

When there is time domain overlapping between PUCCH/PUSCH transmissions with different physical layer priorities, only PUCCH/PUSCH transmission corresponding to a higher physical layer priority is performed, and PUCCH/PUSCH transmission corresponding to a lower physical layer priority is discarded. Within a same physical layer priority, the operation is carried out according to the preset rule, for example, the corresponding operation is executed according to the Case 1 or Case 2.

In another case, the first target UCI includes one of the following:
fusion information obtained by fusing the at least two pieces of UCI; and
a part of UCI selected from the at least two pieces of UCI.

In the foregoing description, the fusion information is determined in any one of the following manners.

Manner 1: as for each of the at least two PUCCH cells, determine first UCI corresponding to each PUCCH cell, and cascade, according to a second preset rule, the first UCI corresponding to each PUCCH cell end to end, to obtain the fusion information.

As for each of the at least two PUCCH cells, in a case that the number of pieces of UCI corresponding to the PUCCH cell is equal to 1, first UCI corresponding to the PUCCH cell is determined as the UCI corresponding to the PUCCH cell; and in a case that the number of pieces of UCI corresponding to the PUCCH cell is greater than 1, the first UCI corresponding to the PUCCH cell is determined based on the UCI corresponding to the PUCCH cell and according to a first preset rule.

For example, as for each PUCCH cell (namely, the PUCCH cell among the at least two PUCCH cells), a bit sequence of UCI that needs to be transmitted and the PUCCH resource are determined first according to the first preset rule, and then the bit sequence of the UCI corresponding to each PUCCH cell is cascaded end to end according to a second preset rule, to obtain the fusion information. The second preset rule may be an ascending or descending order of index values corresponding to the PUCCH cell.

The index value corresponding to the PUCCH cell can be understood as a cell index value corresponding to the PUCCH cell, or an uplink serving cell index (UL Serving cell index) value corresponding to the PUCCH cell, or a local index value of the PUCCH cell in a cell set that allows transmission of the PUCCH. The index value can be numbered from 0, and the index value corresponding to the PUCCH cell involved in this paper follows the description herein.

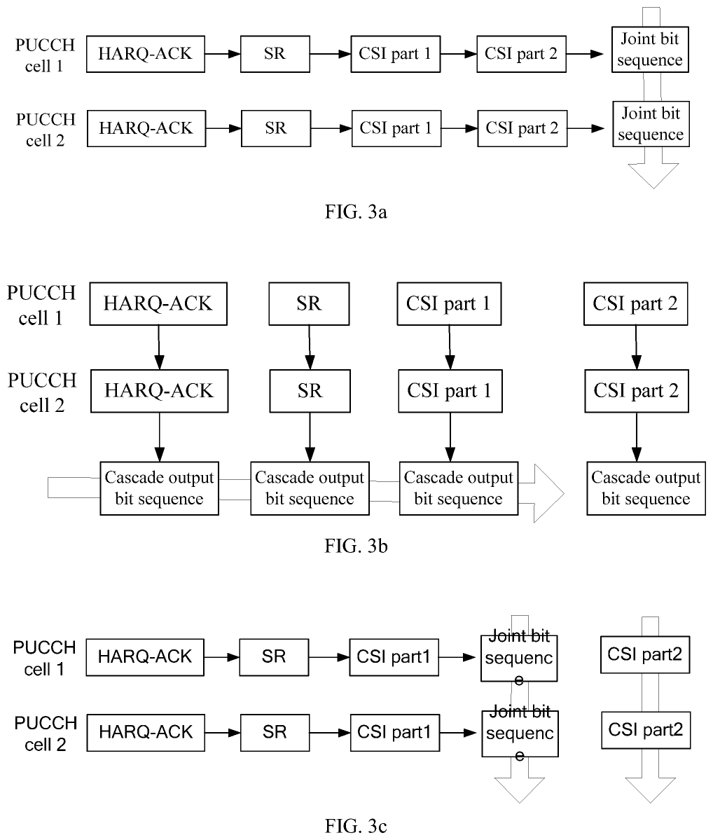

Optionally, a bit sequence of UCI to be transmitted corresponding to each PUCCH cell can be directly various types of UCI to be transmitted in this PUCCH cell (the corresponding bit sequence is obtained through end-to-end cascading according to the first preset rule, that is, bit sequences of UCI of all information types existing in the PUCCH cell are obtained through end-to-end cascading according to the first preset rule). If there is no UCI of a specific information type in this PUCCH cell, this UCI information type is ignored or skipped for this PUCCH cell during cascading. For example, bit sequences corresponding to HARQ-ACK, SR, CSI part 1, and CSI part 2 are sequentially cascaded end to end. As shown in FIG. 3a, the bit sequence of UCI to be transmitted corresponding to each PUCCH cell is directly obtained by cascading a bit sequence corresponding to each UCI end to end.

Manner 2: Determine, based on the at least two pieces of UCI, M classes of UCI to be transmitted, as for a first UCI class among the M classes of UCI, cascade, according to the second preset rule, second UCI corresponding to each first PUCCH cell end to end, to obtain third UCI corresponding to the first UCI class, and cascade, according to a third preset rule, third UCI corresponding to each UCI class end to end, to obtain the fusion information.

The UCI class includes a UCI information type or a UCI transmission requirement, M is an integer greater than or equal to 1, the first UCI class is any UCI class among the M classes of UCI, the first PUCCH cell is any one of the at least two PUCCH cells with at least one piece of UCI corresponding to the first UCI class, the second UCI corresponding to the first PUCCH cell is determined based on the second target UCI corresponding to the first PUCCH cell, and the second target UCI includes at least one piece of UCI corresponding to the first UCI class. The first UCI class may include one information type or two or more information types. For example, the first UCI class may include HARQ-ACK, or may also include HARQ-ACK and SR.

For example, if there are three types of UCI information: HARQ-ACK, SR, and CSI, for HARQ-ACK, UCI corresponding to each PUCCH cell is screened, and a PUCCH cell where the UCI including HARQ-ACK is located is selected. The selected PUCCH cell is referred to as a first PUCCH cell, and the HARQ-ACK on each first PUCCH cell is cascaded end to end according to the second preset rule, to obtain third UCI. The second preset rule is a cross-cell cascade rule.

As for SR, UCI corresponding to each PUCCH cell is screened, and a PUCCH cell where the UCI including SR is located is selected. The selected PUCCH cell is referred to as the first PUCCH cell, and the SR on each first PUCCH cell is cascaded end to end according to the second preset rule, to obtain the third UCI.

As for CSI, UCI corresponding to each PUCCH cell is screened, and a PUCCH cell where the UCI including CSI is located is selected. The selected PUCCH cell is referred to as a first PUCCH cell, and the CSI on each first PUCCH cell is cascaded end to end according to the second preset rule, to obtain the third UCI.

Three pieces of third UCI obtained under the above three types are cascaded end to end according to the third preset rule, to obtain the fusion information.

In the foregoing description, in a case that the number of pieces of UCI corresponding to the first PUCCH cell is equal to 1, second UCI corresponding to the first PUCCH cell is the UCI corresponding to the first PUCCH cell; and in a case that the number of pieces of UCI corresponding to the first PUCCH cell is greater than 1, the second UCI corresponding to the first PUCCH cell is obtained based on the UCI corresponding to the first PUCCH cell and according to a fourth preset rule.

For example, among the at least two pieces of UCI, bit sequences of UCI with a same type or a same transmission requirement can be cascaded end to end across the PUCCH cell according to the second preset rule, and then cascade output bit sequences (that is, output of a first-step cascade operation) with different types or transmission requirements are cascaded end to end according to the third preset rule, to obtain the fusion information. Before processing according to the second preset rule, if the number of pieces of UCI corresponding to the first PUCCH cell is greater than 1, the second UCI corresponding to the first PUCCH cell is obtained based on the UCI corresponding to the first PUCCH cell and according to the fourth preset rule.

For example, in FIG. 3b, various UCI information types are cascaded end to end first across the PUCCH cell, and then the cascade output bit sequence corresponding to each UCI information type is cascaded end to end. As shown in FIG. 3b, firstly, HARQ-ACK, SR, CSI part 1, and CSI part 2 corresponding to each PUCCH cell are respectively cascaded end to end based on an ascending or descending order of the PUCCH cell index. For a specific UCI information type, when there is no corresponding UCI information to be transmitted on a PUCCH cell, the PUCCH cell is ignored (or skipped). Then, cascade output bit sequences corresponding to HARQ-ACK, SR, CSI part 1, and CSI part 2 respectively are cascaded end to end according to the third preset rule, that is, cascade output bit sequences of UCI in all information types with the cascade output bit sequence are obtained according to the third preset rule. If there is no cascade output bit sequence for UCI in a specific information type, the UCI information type is ignored or skipped during cascading. For example, the cascade output bit sequences corresponding to HARQ-ACK, SR, CSI part 1, and CSI part 2 are sequentially cascaded end to end. Optionally, cascade output bit sequences corresponding to HARQ-ACK, SR, and CSI part 1 can be cascaded only, to form a single bit sequence, while CSI part 2 alone corresponds to another bit sequence.

For example, in FIG. 3c, types of UCI information with the same transmission requirement corresponding to PUCCH cells are cascaded end to end first, and then UCI bit sequences with different transmission requirements are cascaded end to end across the PUCCH cell. As shown in FIG. 3c, as for each PUCCH cell, corresponding HARQ-ACK, SR, and CSI part 1 are cascaded end to end according to the fourth preset rule (it is assumed that these UCI information types have the same transmission requirement, and can be jointly coded). For example, it is assumed that UCI transmission requirements of the information type such as HARQ-ACK, SR, and CSI part 1 are the same, then bit sequences corresponding to HARQ-ACK, SR, and CSI part 1 are sequentially cascaded end to end, to obtain a joint bit sequence corresponding to each PUCCH cell, that is, bit sequences of UCI with bit sequences in the information types such as HARQ-ACK, SR, and CSI part 1 are obtained by being cascaded end to end according to the fourth preset rule. If there is no bit sequence for a specific information type, the UCI information type is ignored or skipped during cascading. Then, joint bit sequences corresponding to PUCCH cells are cascaded end to end based on an ascending or descending order of the PUCCH cell index, to obtain a first UCI bit sequence. CSI part 2 corresponding to each PUCCH cell can also be cascaded end to end based on an ascending or descending order of the PUCCH cell index, to obtain a second UCI bit sequence. Optionally, the first UCI bit sequence and the second UCI bit sequence can be further cascaded end to end, to form a single UCI bit sequence.

The first target UCI may include a part of UCI selected from the at least two pieces of UCI. The part of UCI includes any one of the following:
UCI that is among the at least two pieces of UCI and that is corresponding to a second PUCCH cell among the at least two PUCCH cells;
UCI corresponding to a target type among the at least two pieces of UCI; and
UCI with a target transmission requirement among the at least two pieces of UCI.

Specifically, UCI that is corresponding to the second PUCCH cell among the at least two PUCCH cells and that is among the at least two pieces of UCI. That is, to select all pieces of UCI to be transmitted corresponding to a single PUCCH cell, and UCI to be transmitted corresponding to other PUCCH cells will be discarded and will not be transmitted. For the selected UCI corresponding to the single PUCCH cell, the actually transmitted UCI bit sequence can be determined according to the first preset rule, or each UCI to be transmitted is cascaded end to end according to a predefined order/rule.

The single PUCCH cell can be selected in any of the following manners.

Based on the PUCCH cell index. For example, select, from the at least two PUCCH cells, a corresponding PUCCH cell with a maximum index value, or a corresponding PUCCH cell with a minimum index value, or a corresponding PUCCH cell with an index value being a preset index value, and transmit corresponding UCI to be transmitted. The preset index value can be specified in the protocol, or configured based on higher layer signaling, for example, when UCI transmission on more than one PUCCH cell overlaps in time domain, the selected PUCCH cell and/or PUCCH resources are configured by the higher layer signaling.

Based on the physical layer priority, that is, a PUCCH cell selected from the at least two PUCCH cells based on a physical layer priority corresponding to each of the at least two pieces of UCI. For example, a PUCCH cell with a higher physical layer priority or a higher highest physical layer priority can be selected, that is, a physical layer priority or a highest physical layer priority corresponding to the UCI to be transmitted corresponding to each PUCCH cell is determined first, and then the PUCCH cell with the higher physical layer priority or the higher highest physical layer priority is selected from the plurality of PUCCH cells. When there are still a plurality of selected PUCCH cells, the PUCCH cell can be further selected based on the PUCCH cell index or based on a separately configured cell priority.

When the UCI to be transmitted corresponding to the selected PUCCH cell corresponds to two physical layer priorities, it can be considered to simultaneously transmit UCI information corresponding to the two physical layer priorities (considering cross-physical layer priority multiplexing), or only UCI information corresponding to the higher physical layer priority is transmitted.

Based on a separately configured cell priority, that is, a PUCCH cell selected based on a cell priority configured for each of the at least two PUCCH cells. For example, a cell priority can be configured for each PUCCH cell. One PUCCH cell is selected from the at least two PUCCH cells based on the cell priority, for example, the PUCCH cell with the highest cell priority, the lowest cell priority, or a specified value for the cell priority is selected.

Selection is performed based on a resource availability condition of each PUCCH cell, that is, a PUCCH cell selected based on resource availability information for each of the at least two PUCCH cells. For example, select the PUCCH cell in which a time-domain feedback position includes an uplink symbol, or a corresponding PUCCH resource can be used for actual transmission. When there are still a plurality of PUCCH cells selected based on the resource availability condition, the PUCCH cell can be further selected based on the PUCCH cell index or based on a separately configured cell priority.

Optionally, only UCI corresponding to a specific UCI information type among UCI to be transmitted corresponding to the second PUCCH cell is transmitted, and the rest of UCI is discarded, for example, only HARQ-ACK and SR are transmitted, and CSI is discarded, or only HARQ-ACK, SR, and CSI part 1 are transmitted, and CSI part 2 is discarded.

The target PUCCH cell can be determined in any of the following manners.

Selection is performed based on the PUCCH cell index, that is, the target PUCCH cell may be a PUCCH cell selected from the at least two PUCCH cells based on an index value. For example, a PUCCH cell with a minimum, maximum, or specified PUCCH cell index is selected from the plurality of PUCCH cells.

Selection is performed based on the physical layer priority, that is, the target PUCCH cell may be a PUCCH cell selected from the at least two PUCCH cells based on a physical layer priority corresponding to each of the at least two pieces of UCI. For example, a PUCCH cell with a higher physical layer priority or a higher highest physical layer priority can be selected, that is, a physical layer priority or a highest physical layer priority corresponding to the UCI to be transmitted corresponding to each PUCCH cell is determined first, and then the PUCCH cell with the higher physical layer priority or the higher highest physical layer priority is selected from the plurality of PUCCH cells. When there are still a plurality of selected PUCCH cells, the PUCCH cell can be further selected based on the PUCCH cell index or based on a separately configured cell priority.

When the UCI to be transmitted corresponding to the selected PUCCH cell corresponds to two physical layer priorities, it can be considered to simultaneously transmit UCI information corresponding to the two physical layer priorities (considering cross-physical layer priority multiplexing), or only UCI information corresponding to the higher physical layer priority is transmitted.

Selection is performed based on the separately configured cell priority, that is, the target PUCCH cell can perform selection from the at least two PUCCH cells based on a cell priority configured for the PUCCH cell. For example, a cell priority can be configured for each PUCCH cell. One PUCCH cell is selected from the at least two PUCCH cells based on the cell priority, for example, the PUCCH cell with the highest cell priority, the lowest cell priority, or a specified value for the cell priority is selected.

Selection is performed based on the resource availability condition, that is, the target PUCCH cell can perform selection from the at least two PUCCH cells based on the resource availability information of the PUCCH cell. For example, the PUCCH cell in which a time-domain feedback position includes an uplink symbol, or a corresponding PUCCH resource can be used for actual transmission is selected. When there are still a plurality of PUCCH cells selected based on the resource availability condition, the PUCCH cell can be further selected based on the PUCCH cell index or based on a separately configured cell priority.

A second PUCCH cell among the at least two PUCCH cells is selected, where the first target UCI includes a part of or all of UCI corresponding to the second PUCCH cell. In a case that the first target UCI includes a part of UCI, the PUCCH cell corresponding to the part of UCI is directly selected.

A third PUCCH cell among the at least two PUCCH cells is selected, where the third PUCCH cell is a PUCCH cell on which a codebook corresponding to a dynamic scheduling HARQ-ACK needs to be transmitted. When a codebook corresponding to the dynamic scheduling HARQ-ACK is transmitted on a specific PUCCH cell, the PUCCH cell is directly selected.

In a second manner, a plurality of PUCCH cells can be transmitted in parallel. In this case, the transmitting, by the terminal, first target UCI on a target PUCCH cell among the at least one PUCCH cell includes:

in a period with the overlapping in time domain, transmitting, by the terminal, the at least two pieces of UCI simultaneously on the at least two PUCCH cells. Overlapping in time domain exists among PUCCH resources carrying the at least two pieces of UCI, and the PUCCH resources carrying the at least two pieces of UCI are located in at least two PUCCH cells.

For each PUCCH cell with UCI to be transmitted, the bit sequence and the PUCCH resource of the UCI to be transmitted can be determined according to the first preset rule. When PUCCH resources corresponding to PUCCH cells overlap in time domain, parallel PUCCH transmission with partial or complete overlapping in time domain is allowed for these PUCCH cells.

In an embodiment of this application, before the determining, by a terminal based on at least two pieces of UCI, at least one PUCCH cell corresponding to the at least two pieces of UCI, the method further includes:
receiving resource configuration information for UCI.

The resource configuration information includes at least one of the following:
association information between an SR configuration and a scheduling request resource configuration configured on at least one bandwidth part (BWP) of one PUCCH cell;
association information between an SR configuration and a scheduling request resource configuration configured on at least one BWP of N PUCCH cells, where N is an integer greater than 1; and
a CSI reporting configuration configured on a PUCCH cell where corresponding CSI is transmitted.

The following describes the SR resource configuration and the CSI resource configuration respectively.

As for the SR resource configuration, one SR configuration can be associated with (single) scheduling request resource configuration configured on one or more BWPs of one or more PUCCH cells.

PUCCH carrier switching (carrier switching) includes a dynamic manner (namely. Alt. 1) and a semi-static manner (namely, Alt. 2C).

When the dynamic manner of PUCCH carrier switching is used, the single SR configuration can be associated with the scheduling request resource configuration configured on one or more BWPs of a single PUCCH cell, and the scheduling request resource configuration can be a single scheduling request resource configuration.

When the semi-static manner of PUCCH carrier switching is used, the single SR configuration can be associated with the scheduling request resource configuration configured on one or more BWPs of a plurality of PUCCH cells, for example, being associated with N PUCCH cells, where N is the number of centrally included PUCCH cells that are in an active or available state in different time periods based on a time domain pattern, and the N PUCCH cells are the centrally included PUCCH cells. The time domain pattern herein can be configured uniformly for M PUCCH cells in the current PUCCH cell group, or configured separately for each PUCCH cell.

In a case of using PUCCH carrier switching Alt. 2C, when SR transmission corresponding to this SR configuration is triggered (for example, when one or more logical channels associated with this SR configuration trigger Regular BSR, and no suitable UL-SCH resource is available, the SR transmission corresponding to this SR configuration is triggered), the PUCCH cell corresponding to the PUCCH transmission carrying the SR (hereinafter referred to as SR PUCCH) can be determined based on the time domain pattern (optionally, it may not be constrained by the time domain pattern).

Specifically, when it is determined that a scheduling request resource configuration associated with this SR configuration is configured on an activated BWP of a specific PUCCH cell in an activated or available state based on the time domain pattern, the SR PUCCH is transmitted based on the period and the offset configured for the scheduling request resource configuration, and the PUCCH resource. In a process of successively transmitting the SR PUCCH for many times, if the activated/available PUCCH cell changes based on the time domain pattern, the SR PUCCH transmission is also switched/transferred from at least one PUCCH cell (namely, the PUCCH cell in the activated/available state before the above change) to at least one other PUCCH cell (namely, the PUCCH cell in the activated/available state after the above change). When no scheduling request resource configuration associated with this SR configuration is configured on the active BWP of any PUCCH cell after the above change, the SR transmission is interrupted or suspended.

For each scheduling request resource configuration associated with the same SR configuration, a period and an offset thereof can be configured in any one of the following manners (which are applicable when using PUCCH carrier switching Alt. 1 or Alt. 2C; and for an operation that applies to only one specific case, the corresponding explanation will be given below).

Configuration manner 1: the period and the offset are configured uniformly, and are based on a reference SCS or a reference numerology. That is, in a case that a same SR configuration included in the resource configuration information is associated with at least two scheduling request resource configurations, a period and an offset for each of the at least two scheduling request resource configurations are uniformly configured based on a reference subcarrier spacing or a reference numerology.

A main purpose herein is to ensure strict periodicity of the SR transmission. When PUCCH cell switching and/or BWP switching occurs in the process of successively transmitting the SR PUCCH for many times, time intervals between adjacent SR PUCCH transmissions can be ensured to be equal or basically equal (time intervals of the SR PUCCH resource configured on each PUCCH cell and/or BWP are equal).

Optionally, in a case that a single time unit determined based on the reference subcarrier spacing or the reference numerology corresponds to a plurality of time units on the fourth PUCCH cell, a target time unit is selected from the plurality of time units according to a fifth preset rule, to determine an SR PUCCH resource corresponding to the second scheduling request resource configuration. A fourth PUCCH cell is a PUCCH cell corresponding to a second scheduling request resource configuration, and the second scheduling request resource configuration is any one of the at least two scheduling request resource configurations. The time unit may include a slot or a sub-slot.

For example, when a reference slot (namely, a single slot determined based on the reference SCS/numerology) corresponds to a plurality of uplink slots/sub-slots on a specific valid PUCCH cell (the SR PUCCH resource is configured on this PUCCH cell), in a case that the SR PUCCH needs to be transmitted on this PUCCH cell.

As for any SR_{PERIODICITY} configuration,
it needs to be determined which uplink slot/sub-slot in the plurality of uplink slots/sub-slots is specifically selected to transmit the SR PUCCH, and any one of the following manners can be used.

Select a slot/sub-slot that meets a predefined condition, and when there are a plurality of slots/sub-slots that meet the predefined condition, an earliest slot/sub-slot among the plurality of slots/sub-slots can be further selected. For example, select a first slot/sub-slot, a last slot/sub-slot, or a slot/sub-slot with a specified index in the plurality of uplink slots/sub-slots. That is, the target time unit includes one of the following:
a time unit that is able to accommodate the SR PUCCH resource among the plurality of time units;
an earliest time unit that is able to accommodate the SR PUCCH resource among the plurality of time units;
a first time unit among the plurality of time units;
a last time unit among the plurality of time units; and
a time unit corresponding to a first specified index among the plurality of time units.

The predefined condition can be: the SR PUCCH resource to be transmitted can be accommodated. PUCCH resource determination herein requires that corresponding PUCCH transmission can actually be performed, for example, the PUCCH resource does not overlap/conflict with the semi-static DL and symbol/SSB/CORESET #0 symbol.

Optionally, when SR_{PERIODICITY} is sym2 or sym6 or 7, any of the following manners can be used.

Configuration manner 1-1: this periodic configuration is not allowed to avoid corresponding processing.

Configuration manner 1-2: it is required that start moments or absolute start moments of the SR PUCCH resources on PUCCH cells associated with the same SR configuration should be aligned, and an interval between start moments of adjacent PUCCH resources or transmission occasions is absolute duration corresponding to SR_{PERIODICITY} (which can be determined based on the reference SCS or numerology), thus ensuring periodicity between adjacent SR PUCCH resources in time domain when PUCCH cell switching and/or BWP switching occur.

Configuration manner 1-3: the operation of selecting a single uplink slot/sub-slot from a plurality of uplink slots/sub-slots, which is applicable to “any configuration”, is followed, and SR_{PERIODICITY} is applied to the selected single uplink slot/sub-slot.

Configuration manner 2: each scheduling request resource configuration is configured with a corresponding period and offset, and based on an SCS or numerology corresponding to a PUCCH cell and a UL BWP thereof. That is, in a case that a same SR configuration included in the resource configuration information is associated with at least two scheduling request resource configurations, a first scheduling request resource configuration among the at least two scheduling request resource configurations is configured based on target information, where the first scheduling request resource configuration is any one of the at least two scheduling request resource configurations, and the target information is a subcarrier spacing or a numerology corresponding to a PUCCH cell and an uplink (UL) BWP in which the first scheduling request resource configuration is located.

As for CSI resource configuration: CSI-ReportConfig corresponding to periodic CSI or semi-persistent CSI reporting is configured on a PUCCH cell that transmits a PUCCH carrying the periodic CSI or semi-persistent CSI. Each PUCCH cell can be independently configured with CSI-ReportConfig corresponding to the periodic CSI or semi-persistent CSI reporting.

As for the periodic CSI on PUCCH, when an active BWP of a PUCCH cell in which the periodic CSI on PUCCH is located (or corresponding to) is an uplink BWP configured by the periodic CSI reporting, it is considered to be in an active state, otherwise it is in a suspended state. Optionally, when the PUCCH carrier switching Alt. 2C is used, as for the periodic CSI on PUCCH, when a PUCCH cell in which the periodic CSI on PUCCH is located (or corresponding to) is in an active or available state based on the time domain pattern, and when the active BWP of this PUCCH cell is an uplink BWP configured by the periodic CSI reporting, it is considered to be in an active state, otherwise it is in a suspended state.

After being activated based on media access control (MAC) control element (CE), if semi-persistent CSI on PUCCH is not deactivated by the MAC CE, when the active BWP of a PUCCH cell in which the semi-persistent CSI on PUCCH is located (or corresponding to) is an uplink BWP configured by the semi-persistent CSI reporting, it is considered to be in an active state, otherwise it is in a suspended state. Optionally, when the PUCCH carrier switching Alt. 2C is used, after being activated based on the MAC CE, if semi-persistent CSI on PUCCH is not deactivated by the MAC CE, when a PUCCH cell in which the semi-persistent CSI on PUCCH is located (or corresponding to) is in an active/available state based on the time domain pattern, and when the active BWP of this PUCCH cell is an uplink BWP configured by the semi-persistent CSI reporting, it is considered to be in an active state, otherwise it is in a suspended state.

When the PUCCH carrier switching Alt. 2C is used, generally, it can be assumed that only a single PUCCH cell is actually valid or in an active state at a specific moment based on the time domain pattern, and then a UCI multiplexing or prioritization (Prioritization) operation can be performed on this PUCCH cell according to a specific protocol rule.

As for PUCCH carrier switching, when dynamic indication manner Alt. 1 is used, an HARQ-ACK feedback delay can be shortened for multiplexing and transmission between different UCI information types, and transmission performance of other UCI information types can be further guaranteed. Other UCI information types can be used to synchronously switch the PUCCH cell based on PUCCH cell switching of DG HARQ-ACK and according to a corresponding multiplexing rule, to ensure transmission of the PUCCH cell.

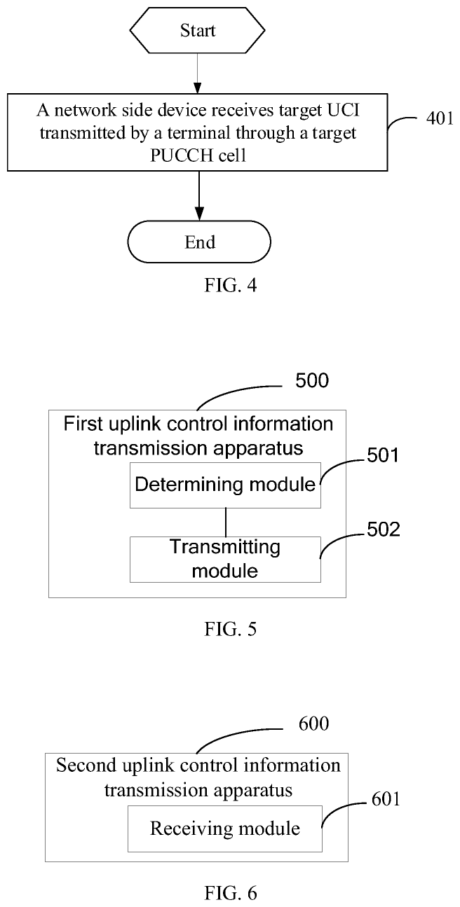

Referring to FIG. 4, FIG. 4 is a flowchart of an uplink control information transmission method according to an embodiment of this application. As shown in FIG. 4, the uplink control information transmission method provided in this embodiment of this application includes the following steps.

Step 401. A network side device receives first target UCI transmitted by a terminal through a target physical uplink control channel (PUCCH) cell.

The target PUCCH cell is a cell in at least one PUCCH cell, the at least one PUCCH cell is determined based on at least two pieces of uplink control information (UCI), and the first target UCI is determined based on the at least two pieces of UCI.

In this embodiment, the network side device receives the first target UCI transmitted by the terminal through the target physical uplink control channel (PUCCH) cell, where the target PUCCH cell is a cell in at least one PUCCH cell, the at least one PUCCH cell is determined based on at least two pieces of uplink control information (UCI), and the first target UCI is determined based on the at least two pieces of UCI. Transmitting the first target UCI on the target PUCCH cell can improve transmission performance of the at least two pieces of UCI.

Optionally, the UCI includes at least one of the following:
a hybrid automatic repeat request acknowledgement (HARQ-ACK);
a scheduling request (SR); and
channel state information (CSI).

Optionally, the at least one PUCCH cell includes at least one of the following:
in a case that the at least two pieces of UCI include a first dynamic scheduling HARQ-ACK, the at least one PUCCH cell includes a PUCCH cell corresponding to the first dynamic scheduling HARQ-ACK, and the first dynamic scheduling HARQ-ACK is indicated by a first type of DCI;
in a case that the at least two pieces of UCI include a second dynamic scheduling HARQ-ACK and at least one third dynamic scheduling HARQ-ACK, the at least one PUCCH cell includes a PUCCH cell corresponding to the third dynamic scheduling HARQ-ACK, the second dynamic scheduling HARQ-ACK is indicated by a second type of DCI, the third dynamic scheduling HARQ-ACK is indicated by the first type of DCI, and the second dynamic scheduling HARQ-ACK and the at least one third dynamic scheduling HARQ-ACK are transmitted in a same HARQ-ACK codebook;
in a case that the at least two pieces of UCI include semi-persistent scheduling (SPS) HARQ-ACK, or the at least two pieces of UCI include a dynamic scheduling HARQ-ACK indicated by the second type of DCI, and the dynamic scheduling HARQ-ACK indicated by the second type of DCI is not transmitted, in a same HARQ-ACK codebook, with any dynamic scheduling HARQ-ACK indicated by the first type of DCI, the at least one PUCCH cell includes a PUCCH cell configured according to a protocol or based on higher layer signaling;
in a case that the at least two pieces of UCI include SPS HARQ-ACK, the at least one PUCCH cell includes a PUCCH cell dynamically indicated by SPS activation or reactivation DCI;
in a case that the at least two pieces of UCI include an SR corresponding to one SR configuration, the at least one PUCCH cell includes a PUCCH cell corresponding to first PUCCH transmission, where the first PUCCH transmission is PUCCH transmission corresponding to a scheduling request resource configuration associated with one SR configuration;
in a case that the at least two pieces of UCI include periodic CSI, the at least one PUCCH cell includes a PUCCH cell configured with a first CSI reporting configuration, where the first CSI reporting configuration is a CSI reporting configuration corresponding to the periodic CSI carried on PUCCH; and
in a case that the at least two pieces of UCI include semi-persistent CSI, the at least one PUCCH cell includes a PUCCH cell configured with a second CSI reporting configuration, where the second CSI reporting configuration is a CSI reporting configuration corresponding to the semi-persistent CSI carried on PUCCH.

Optionally, overlapping in time domain exists among PUCCH resources carrying the at least two pieces of UCI, and the PUCCH resources carrying the at least two pieces of UCI are located in at least two PUCCH cells; and
the target PUCCH cell is one of the at least two PUCCH cells, and the first target UCI is determined based on the at least two pieces of UCI.

Optionally, overlapping in time domain exists among PUCCH resources carrying the at least two pieces of UCI, and the PUCCH resources carrying the at least two pieces of UCI are located in at least two PUCCH cells; and the target PUCCH cell includes the at least two PUCCH cells, and the first target UCI includes the at least two pieces of UCI.

Optionally, the first target UCI is determined according to a first preset rule based on the at least two pieces of UCI, and an attribute and a time domain overlapping situation of a PUCCH resource corresponding to each of the at least two pieces of UCI; and
the target PUCCH cell is a PUCCH cell corresponding to a PUCCH resource carrying the first target UCI.

Optionally, the first target UCI includes one of the following:
fusion information obtained by fusing the at least two pieces of UCI; and
a part of UCI selected from the at least two pieces of UCI.

Optionally, the fusion information is determined in any one of the following manners:
as for each of the at least two PUCCH cells, determining first UCI corresponding to each PUCCH cell, and cascading, according to a second preset rule, the first UCI corresponding to each PUCCH cell end to end, to obtain the fusion information; and
determining, based on the at least two pieces of UCI, M classes of UCI to be transmitted, as for a first UCI class among the M classes of UCI, cascading, according to the second preset rule, second UCI corresponding to each first PUCCH cell end to end, to obtain third UCI corresponding to the first UCI class, and cascading, according to a third preset rule, third UCI corresponding to each UCI class end to end, to obtain the fusion information, where the UCI class includes a UCI information type or a UCI transmission requirement, M is an integer greater than or equal to 1, the first UCI class is any UCI class among the M classes of UCI, the first PUCCH cell is any one of PUCCH cell with second target UCI from the at least two PUCCH cells, and the second target UCI includes at least one piece of UCI corresponding to the first UCI class; and the second UCI corresponding to the first PUCCH cell is determined based on the first target UCI corresponding to the first PUCCH cell.

Optionally, the first UCI corresponding to the PUCCH cell is determined in the following manners:
in a case that the number of pieces of UCI corresponding to the PUCCH cell is equal to 1, determining the first UCI corresponding to the PUCCH cell as the UCI corresponding to the PUCCH cell; and
in a case that the number of pieces of UCI corresponding to the PUCCH cell is greater than 1, determining the first UCI corresponding to the PUCCH cell based on the UCI corresponding to the PUCCH cell and according to a first preset rule.

Optionally, in a case that the number of pieces of UCI corresponding to the first PUCCH cell is equal to 1, second UCI corresponding to the first PUCCH cell is the UCI corresponding to the first PUCCH cell; and in a case that the number of pieces of UCI corresponding to the first PUCCH cell is greater than 1, the second UCI corresponding to the first PUCCH cell is obtained based on the UCI corresponding to the first PUCCH cell and according to a fourth preset rule.

Optionally, the part of UCI includes any one of the following:
UCI that is among the at least two pieces of UCI and that is corresponding to a second PUCCH cell among the at least two PUCCH cells;
UCI corresponding to a target type among the at least two pieces of UCI; and
UCI with a target transmission requirement among the at least two pieces of UCI.

Optionally, the second PUCCH cell includes any one of the following:
a PUCCH cell with a maximum index value among the at least two PUCCH cells;
a PUCCH cell with a minimum index value among the at least two PUCCH cells;
a PUCCH cell with an index value being a preset index value among the at least two PUCCH cells;
a PUCCH cell selected from the at least two PUCCH cells based on a physical layer priority corresponding to each of the at least two pieces of UCI;
a PUCCH cell selected based on a cell priority configured for each of the at least two PUCCH cells; and
a PUCCH cell selected based on resource availability information for each of the at least two PUCCH cells.

Optionally, the target PUCCH cell includes any one of the following:
a PUCCH cell selected from the at least two PUCCH cells based on an index value;
a PUCCH cell selected from the at least two PUCCH cells based on a physical layer priority corresponding to each of the at least two pieces of UCI;
a PUCCH cell selected based on a cell priority configured for each of the at least two PUCCH cells;
a PUCCH cell selected based on resource availability information for each of the at least two PUCCH cells;
a second PUCCH cell among the at least two PUCCH cells, where the first target UCI includes a part of or all of UCI corresponding to the second PUCCH cell; and
a third PUCCH cell among the at least two PUCCH cells, where the third PUCCH cell is a PUCCH cell on which a codebook corresponding to a dynamic scheduling HARQ-ACK needs to be transmitted.

Optionally, the method further includes: sending resource configuration information of UCI.

Optionally, the resource configuration information includes at least one of the following:
association information between an SR configuration and a scheduling request resource configuration configured on at least one bandwidth part (BWP) of one PUCCH cell;
association information between an SR configuration and a scheduling request resource configuration configured on at least one BWP of N PUCCH cells, where N is an integer greater than 1; and
a CSI reporting configuration configured on a PUCCH cell where corresponding CSI is transmitted.

Optionally, in a case that a same SR configuration included in the resource configuration information is associated with at least two scheduling request resource configurations:
a period and an offset for each of the at least two scheduling request resource configurations are uniformly configured based on a reference subcarrier spacing or a reference numerology;
or
a first scheduling request resource configuration among the at least two scheduling request resource configurations is configured based on target information, where the first scheduling request resource configuration is any one of the at least two scheduling request resource configurations, and the target information is a subcarrier spacing or a numerology corresponding to a PUCCH cell and an uplink (UL) BWP in which the first scheduling request resource configuration is located.

Optionally, a fourth PUCCH cell is a PUCCH cell corresponding to a second scheduling request resource configuration, and the second scheduling request resource configuration is any one of the at least two scheduling request resource configurations; and
in a case that a single time unit determined based on the reference subcarrier spacing or the reference numerology corresponds to a plurality of time units on the fourth PUCCH cell, a target time unit is selected from the plurality of time units according to a fifth preset rule, to determine an SR PUCCH resource corresponding to the second scheduling request resource configuration.

Optionally, the target time unit includes one of the following:
a time unit that is able to accommodate the SR PUCCH resource among the plurality of time units;
an earliest time unit that is able to accommodate the SR PUCCH resource among the plurality of time units;
a first time unit among the plurality of time units;
a last time unit among the plurality of time units; and
a time unit corresponding to a first specified index among the plurality of time units.

The above related content can be found in the embodiment of the terminal side described in FIG. 2, and details are not described herein again.

Referring to FIG. 5, FIG. 5 is a structural diagram of an uplink control information transmission apparatus according to an embodiment of this application, and the first uplink control information transmission apparatus 500 includes:
a determining module 501, configured to determine, based on at least two pieces of uplink control information (UCI), at least one physical uplink control channel (PUCCH) cell corresponding to the at least two pieces of UCI; and
a transmitting module 502, configured to transmit first target UCI on a target PUCCH cell among the at least one PUCCH cell, where the first target UCI is determined based on the at least two pieces of UCI.

Optionally, the UCI includes at least one of the following:
a hybrid automatic repeat request acknowledgement (HARQ-ACK);
a scheduling request (SR); and
channel state information (CSI).

Optionally, in a case that the at least two pieces of UCI include a first dynamic scheduling HARQ-ACK, the at least one PUCCH cell includes a PUCCH cell corresponding to the first dynamic scheduling HARQ-ACK, and the first dynamic scheduling HARQ-ACK is indicated by a first type of DCI;
in a case that the at least two pieces of UCI include a second dynamic scheduling HARQ-ACK and at least one third dynamic scheduling HARQ-ACK, the at least one PUCCH cell includes a PUCCH cell corresponding to the third dynamic scheduling HARQ-ACK, the second dynamic scheduling HARQ-ACK is indicated by a second type of DCI, the third dynamic scheduling HARQ-ACK is indicated by the first type of DCI, and the second dynamic scheduling HARQ-ACK and the at least one third dynamic scheduling HARQ-ACK are transmitted in a same HARQ-ACK codebook;
in a case that the at least two pieces of UCI include semi-persistent scheduling (SPS) HARQ-ACK, or the at least two pieces of UCI include a dynamic scheduling HARQ-ACK indicated by the second type of DCI, and the dynamic scheduling HARQ-ACK indicated by the second type of DCI is not transmitted, in a same HARQ-ACK codebook, with any dynamic scheduling HARQ-ACK indicated by the first type of DCI, the at least one PUCCH cell includes a PUCCH cell configured according to a protocol or based on higher layer signaling;
in a case that the at least two pieces of UCI include SPS HARQ-ACK, the at least one PUCCH cell includes a PUCCH cell dynamically indicated by SPS activation or reactivation DCI;
in a case that the at least two pieces of UCI include an SR corresponding to one SR configuration, the at least one PUCCH cell includes a PUCCH cell corresponding to first PUCCH transmission, where the first PUCCH transmission is PUCCH transmission corresponding to a scheduling request resource configuration associated with one SR configuration;
in a case that the at least two pieces of UCI include periodic CSI, the at least one PUCCH cell includes a PUCCH cell configured with a first CSI reporting configuration, where the first CSI reporting configuration is a CSI reporting configuration corresponding to the periodic CSI carried on PUCCH; and
in a case that the at least two pieces of UCI include semi-persistent CSI, the at least one PUCCH cell includes a PUCCH cell configured with a second CSI reporting configuration, where the second CSI reporting configuration is a CSI reporting configuration corresponding to the semi-persistent CSI carried on PUCCH.

Optionally, overlapping in time domain exists among PUCCH resources carrying the at least two pieces of UCI, and the PUCCH resources carrying the at least two pieces of UCI are located in at least two PUCCH cells; and
the transmitting module 502 is configured to: in a period with the overlapping in time domain, transmit the at least two pieces of UCI simultaneously on the at least two PUCCH cells.

Optionally, the first target UCI is determined according to a first preset rule based on the at least two pieces of UCI, and an attribute and a time domain overlapping situation of a PUCCH resource corresponding to each of the at least two pieces of UCI; and
the target PUCCH cell is a PUCCH cell corresponding to a PUCCH resource carrying the first target UCI.

Optionally, the first target UCI includes one of the following:
fusion information obtained by fusing the at least two pieces of UCI; and
a part of UCI selected from the at least two pieces of UCI.

Optionally, the fusion information is determined in any one of the following manners:
as for each of the at least two PUCCH cells, determining first UCI corresponding to each PUCCH cell, and cascading, according to a second preset rule, the first UCI corresponding to each PUCCH cell end to end, to obtain the fusion information; and
determining, based on the at least two pieces of UCI, M classes of UCI to be transmitted, as for a first UCI class among the M classes of UCI, cascading, according to the second preset rule, second UCI corresponding to each first PUCCH cell end to end, to obtain third UCI corresponding to the first UCI class, and cascading, according to a third preset rule, third UCI corresponding to each UCI class end to end, to obtain the fusion information, where the UCI class includes a UCI information type or a UCI transmission requirement, M is an integer greater than or equal to 1, the first UCI class is any UCI class among the M classes of UCI, the first PUCCH cell is any one of PUCCH cell with second target UCI from the at least two PUCCH cells, and the second target UCI includes at least one piece of UCI corresponding to the first UCI class; and the second UCI corresponding to the first PUCCH cell is determined based on the first target UCI corresponding to the first PUCCH cell.

Optionally, the first UCI corresponding to the PUCCH cell is determined in the following manners:
in a case that the number of pieces of UCI corresponding to the PUCCH cell is equal to 1, determining the first UCI corresponding to the PUCCH cell as the UCI corresponding to the PUCCH cell; and
in a case that the number of pieces of UCI corresponding to the PUCCH cell is greater than 1, determining the first UCI corresponding to the PUCCH cell based on the UCI corresponding to the PUCCH cell and according to a first preset rule.

Optionally, in a case that the number of pieces of UCI corresponding to the first PUCCH cell is equal to 1, second UCI corresponding to the first PUCCH cell is the UCI corresponding to the first PUCCH cell; and in a case that the number of pieces of UCI corresponding to the first PUCCH cell is greater than 1, the second UCI corresponding to the first PUCCH cell is obtained based on the UCI corresponding to the first PUCCH cell and according to a fourth preset rule.

Optionally, the part of UCI includes any one of the following:
UCI that is among the at least two pieces of UCI and that is corresponding to a second PUCCH cell among the at least two PUCCH cells;
UCI corresponding to a target type among the at least two pieces of UCI; and
UCI with a target transmission requirement among the at least two pieces of UCI.

Optionally, the second PUCCH cell includes any one of the following:
a PUCCH cell with a maximum index value among the at least two PUCCH cells;
a PUCCH cell with a minimum index value among the at least two PUCCH cells;
a PUCCH cell with an index value being a preset index value among the at least two PUCCH cells;
a PUCCH cell selected from the at least two PUCCH cells based on a physical layer priority corresponding to each of the at least two pieces of UCI;
a PUCCH cell selected based on a cell priority configured for each of the at least two PUCCH cells; and
a PUCCH cell selected based on resource availability information for each of the at least two PUCCH cells.

Optionally, the target PUCCH cell includes any one of the following:
a PUCCH cell selected from the at least two PUCCH cells based on an index value;
a PUCCH cell selected from the at least two PUCCH cells based on a physical layer priority corresponding to each of the at least two pieces of UCI;
a PUCCH cell selected based on a cell priority configured for each of the at least two PUCCH cells;
a PUCCH cell selected based on resource availability information for each of the at least two PUCCH cells;
a second PUCCH cell among the at least two PUCCH cells, where the first target UCI includes a part of or all of UCI corresponding to the second PUCCH cell; and
a third PUCCH cell among the at least two PUCCH cells, where the third PUCCH cell is a PUCCH cell on which a codebook corresponding to a dynamic scheduling HARQ-ACK needs to be transmitted.

Optionally, the apparatus further includes a receiving module, configured to receive resource configuration information of UCI.

Optionally, the resource configuration information includes at least one of the following:
association information between an SR configuration and a scheduling request resource configuration configured on at least one bandwidth part (BWP) of one PUCCH cell;
association information between an SR configuration and a scheduling request resource configuration configured on at least one BWP of N PUCCH cells, where Nis an integer greater than 1; and
a CSI reporting configuration configured on a PUCCH cell where corresponding CSI is transmitted.

Optionally, in a case that a same SR configuration included in the resource configuration information is associated with at least two scheduling request resource configurations:
a period and an offset for each of the at least two scheduling request resource configurations are uniformly configured based on a reference subcarrier spacing or a reference numerology;
or
a first scheduling request resource configuration among the at least two scheduling request resource configurations is configured based on target information, where the first scheduling request resource configuration is any one of the at least two scheduling request resource configurations, and the target information is a subcarrier spacing or a numerology corresponding to a PUCCH cell and an uplink (UL) BWP in which the first scheduling request resource configuration is located.

Optionally, a fourth PUCCH cell is a PUCCH cell corresponding to a second scheduling request resource configuration, and the second scheduling request resource configuration is any one of the at least two scheduling request resource configurations; and
in a case that a single time unit determined based on the reference subcarrier spacing or the reference numerology corresponds to a plurality of time units on the fourth PUCCH cell, a target time unit is selected from the plurality of time units according to a fifth preset rule, to determine an SR PUCCH resource corresponding to the second scheduling request resource configuration.

Optionally, the target time unit includes one of the following:
a time unit that is able to accommodate the SR PUCCH resource among the plurality of time units;
an earliest time unit that is able to accommodate the SR PUCCH resource among the plurality of time units;
a first time unit among the plurality of time units;
a last time unit among the plurality of time units; and
a time unit corresponding to a first specified index among the plurality of time units.

The first uplink control information transmission apparatus 500 in this embodiment of this application may be an apparatus, or may be a component, an integrated circuit, or a chip in a terminal.

The first uplink control information transmission apparatus 500 in this embodiment of this application may be an apparatus with an operating system. The operating system may be an Android operating system, an iOS operating system, or another possible operating system, which is not specifically limited in the embodiments of this application.

The first uplink control information transmission apparatus 500 provided in this embodiment of this application can implement the processes implemented in the method embodiment in FIG. 2, and achieve a same technical effect. To avoid repetition, details are not described herein again.

Referring to FIG. 6, FIG. 6 is a structural diagram of an uplink control information transmission apparatus according to an embodiment of this application, and the second uplink control information transmission apparatus 600 includes:
a receiving module 601, configured to receive first target UCI transmitted by a terminal through a target physical uplink control channel (PUCCH) cell, where
the target PUCCH cell is a cell in at least one PUCCH cell, the at least one PUCCH cell is determined based on at least two pieces of uplink control information (UCI), and the first target UCI is determined based on the at least two pieces of UCI.

Optionally, the UCI includes at least one of the following:
a hybrid automatic repeat request acknowledgement (HARQ-ACK);
a scheduling request (SR); and
channel state information (CSI).

Optionally, in a case that the at least two pieces of UCI include a first dynamic scheduling HARQ-ACK, the at least one PUCCH cell includes a PUCCH cell corresponding to the first dynamic scheduling HARQ-ACK, and the first dynamic scheduling HARQ-ACK is indicated by a first type of DCI;
in a case that the at least two pieces of UCI include a second dynamic scheduling HARQ-ACK and at least one third dynamic scheduling HARQ-ACK, the at least one PUCCH cell includes a PUCCH cell corresponding to the third dynamic scheduling HARQ-ACK, the second dynamic scheduling HARQ-ACK is indicated by a second type of DCI, the third dynamic scheduling HARQ-ACK is indicated by the first type of DCI, and the second dynamic scheduling HARQ-ACK and the at least one third dynamic scheduling HARQ-ACK are transmitted in a same HARQ-ACK codebook;
in a case that the at least two pieces of UCI include semi-persistent scheduling (SPS) HARQ-ACK, or the at least two pieces of UCI include a dynamic scheduling HARQ-ACK indicated by the second type of DCI, and the dynamic scheduling HARQ-ACK indicated by the second type of DCI is not transmitted, in a same HARQ-ACK codebook, with any dynamic scheduling HARQ-ACK indicated by the first type of DCI, the at least one PUCCH cell includes a PUCCH cell configured according to a protocol or based on higher layer signaling;
in a case that the at least two pieces of UCI include SPS HARQ-ACK, the at least one PUCCH cell includes a PUCCH cell dynamically indicated by SPS activation or reactivation DCI;
in a case that the at least two pieces of UCI include an SR corresponding to one SR configuration, the at least one PUCCH cell includes a PUCCH cell corresponding to first PUCCH transmission, where the first PUCCH transmission is PUCCH transmission corresponding to a scheduling request resource configuration associated with one SR configuration;
in a case that the at least two pieces of UCI include periodic CSI, the at least one PUCCH cell includes a PUCCH cell configured with a first CSI reporting configuration, where the first CSI reporting configuration is a CSI reporting configuration corresponding to the periodic CSI carried on PUCCH; and
in a case that the at least two pieces of UCI include semi-persistent CSI, the at least one PUCCH cell includes a PUCCH cell configured with a second CSI reporting configuration, where the second CSI reporting configuration is a CSI reporting configuration corresponding to the semi-persistent CSI carried on PUCCH.

Optionally, overlapping in time domain exists among PUCCH resources carrying the at least two pieces of UCI, and the PUCCH resources carrying the at least two pieces of UCI are located in at least two PUCCH cells; and
the target PUCCH cell is one of the at least two PUCCH cells, and the first target UCI is determined based on the at least two pieces of UCI.

Optionally, overlapping in time domain exists among PUCCH resources carrying the at least two pieces of UCI, and the PUCCH resources carrying the at least two pieces of UCI are located in at least two PUCCH cells; and
the target PUCCH cell includes the at least two PUCCH cells, and the first target UCI includes the at least two pieces of UCI.

Optionally, the first target UCI is determined according to a first preset rule based on the at least two pieces of UCI, and an attribute and a time domain overlapping situation of a PUCCH resource corresponding to each of the at least two pieces of UCI; and
the target PUCCH cell is a PUCCH cell corresponding to a PUCCH resource carrying the first target UCI.

Optionally, the first target UCI includes one of the following:
fusion information obtained by fusing the at least two pieces of UCI; and a part of UCI selected from the at least two pieces of UCI.

Optionally, the fusion information is determined in any one of the following manners:
as for each of the at least two PUCCH cells, determining first UCI corresponding to each PUCCH cell, and cascading, according to a second preset rule, the first UCI corresponding to each PUCCH cell end to end, to obtain the fusion information; and
determining, based on the at least two pieces of UCI, M classes of UCI to be transmitted, as for a first UCI class among the M classes of UCI, cascading, according to the second preset rule, second UCI corresponding to each first PUCCH cell end to end, to obtain third UCI corresponding to the first UCI class, and cascading, according to a third preset rule, third UCI corresponding to each UCI class end to end, to obtain the fusion information, where the UCI class includes a UCI information type or a UCI transmission requirement, M is an integer greater than or equal to 1, the first UCI class is any UCI class among the M classes of UCI, the first PUCCH cell is any one of PUCCH cell with second target UCI from the at least two PUCCH cells, and the second target UCI includes at least one piece of UCI corresponding to the first UCI class; and the second UCI corresponding to the first PUCCH cell is determined based on the first target UCI corresponding to the first PUCCH cell.

Optionally, the first UCI corresponding to the PUCCH cell is determined in the following manners:
in a case that the number of pieces of UCI corresponding to the PUCCH cell is equal to 1, determining the first UCI corresponding to the PUCCH cell as the UCI corresponding to the PUCCH cell; and
in a case that the number of pieces of UCI corresponding to the PUCCH cell is greater than 1, determining the first UCI corresponding to the PUCCH cell based on the UCI corresponding to the PUCCH cell and according to a first preset rule.

Optionally, in a case that the number of pieces of UCI corresponding to the first PUCCH cell is equal to 1, second UCI corresponding to the first PUCCH cell is the UCI corresponding to the first PUCCH cell; and in a case that the number of pieces of UCI corresponding to the first PUCCH cell is greater than 1, the second UCI corresponding to the first PUCCH cell is obtained based on the UCI corresponding to the first PUCCH cell and according to a fourth preset rule.

Optionally, the part of UCI includes any one of the following:
UCI that is among the at least two pieces of UCI and that is corresponding to a second PUCCH cell among the at least two PUCCH cells;
UCI corresponding to a target type among the at least two pieces of UCI; and
UCI with a target transmission requirement among the at least two pieces of UCI.

Optionally, the second PUCCH cell includes any one of the following:
a PUCCH cell with a maximum index value among the at least two PUCCH cells;
a PUCCH cell with a minimum index value among the at least two PUCCH cells;
a PUCCH cell with an index value being a preset index value among the at least two PUCCH cells;
a PUCCH cell selected from the at least two PUCCH cells based on a physical layer priority corresponding to each of the at least two pieces of UCI;
a PUCCH cell selected based on a cell priority configured for each of the at least two PUCCH cells; and
a PUCCH cell selected based on resource availability information for each of the at least two PUCCH cells.

Optionally, the target PUCCH cell includes any one of the following:
a PUCCH cell selected from the at least two PUCCH cells based on an index value;
a PUCCH cell selected from the at least two PUCCH cells based on a physical layer priority corresponding to each of the at least two pieces of UCI;
a PUCCH cell selected based on a cell priority configured for each of the at least two PUCCH cells;
a PUCCH cell selected based on resource availability information for each of the at least two PUCCH cells;
a second PUCCH cell among the at least two PUCCH cells, where the first target UCI includes a part of or all of UCI corresponding to the second PUCCH cell; and
a third PUCCH cell among the at least two PUCCH cells, where the third PUCCH cell is a PUCCH cell on which a codebook corresponding to a dynamic scheduling HARQ-ACK needs to be transmitted.

Optionally, the apparatus further includes a sending module, configured to send resource configuration information of UCI.

Optionally, the resource configuration information includes at least one of the following:
association information between an SR configuration and a scheduling request resource configuration configured on at least one bandwidth part (BWP) of one PUCCH cell;
association information between an SR configuration and a scheduling request resource configuration configured on at least one BWP of N PUCCH cells, where Nis an integer greater than 1; and
a CSI reporting configuration configured on a PUCCH cell where corresponding CSI is transmitted.

Optionally, in a case that a same SR configuration included in the resource configuration information is associated with at least two scheduling request resource configurations:
a period and an offset for each of the at least two scheduling request resource configurations are uniformly configured based on a reference subcarrier spacing or a reference numerology; or
a first scheduling request resource configuration among the at least two scheduling request resource configurations is configured based on target information, where the first scheduling request resource configuration is any one of the at least two scheduling request resource configurations, and the target information is a subcarrier spacing or a numerology corresponding to a PUCCH cell and an uplink (UL) BWP in which the first scheduling request resource configuration is located.

Optionally, a fourth PUCCH cell is a PUCCH cell corresponding to a second scheduling request resource configuration, and the second scheduling request resource configuration is any one of the at least two scheduling request resource configurations; and
in a case that a single time unit determined based on the reference subcarrier spacing or the reference numerology corresponds to a plurality of time units on the fourth PUCCH cell, a target time unit is selected from the plurality of time units according to a fifth preset rule, to determine an SR PUCCH resource corresponding to the second scheduling request resource configuration.

Optionally, the target time unit includes one of the following:
a time unit that is able to accommodate the SR PUCCH resource among the plurality of time units;
an earliest time unit that is able to accommodate the SR PUCCH resource among the plurality of time units;
a first time unit among the plurality of time units;
a last time unit among the plurality of time units; and
a time unit corresponding to a first specified index among the plurality of time units.

The second uplink control information transmission apparatus 600 provided in this embodiment of this application can implement the processes implemented in the method embodiment in FIG. 4, and achieve a same technical effect. To avoid repetition, details are not described herein again.

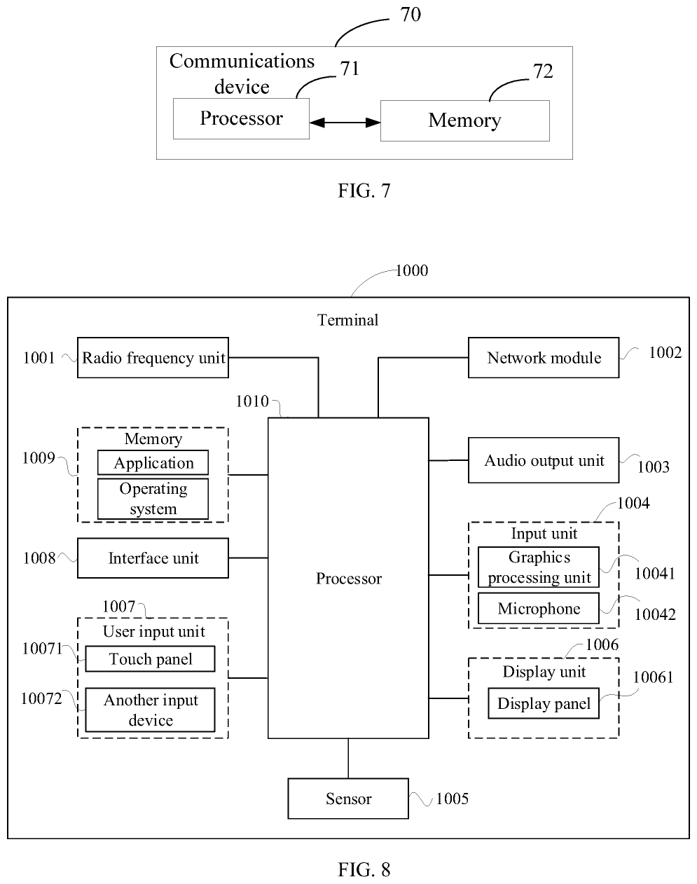

Optionally, as shown in FIG. 7, an embodiment of this application also provides a communications device 70, including a processor 71, a memory 72, and a program or an instruction stored in the memory 72 and executable on the processor 71. For example, in a case that the communications device 70 is a terminal, when the program or the instruction is executed by the processor 71, the processes of the uplink control information transmission method embodiment in FIG. 2 are implemented, and a same technical effect can be achieved. In a case that the communications device 70 is a network side device, when the program or the instruction is executed by the processor 71, the processes of the uplink control information transmission method embodiment shown in FIG. 4 can be implemented, and a same technical effect can be achieved.

FIG. 8 is a schematic diagram of a hardware structure of a terminal according to an embodiment of this application.

The terminal 1000 includes but is not limited to components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 8 constitutes no limitation on the terminal, and the terminal may include more or fewer components than those shown in the figure, or combine some components, or have different component arrangements. Details are not described herein.

It should be understood that, in this embodiment of this application, the input unit 1004 may include a graphics processing unit (GPU) 10041 and a microphone 10042, and the graphics processing unit 10041 processes image data of a still picture or a video obtained by an image capture apparatus (such as a camera) in a video capture mode or an image capture mode. The display unit 1006 may include a display panel 10061. Optionally, the display panel 10061 may be configured in a form such as a liquid crystal display or an organic light-emitting diode. The user input unit 1007 includes a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1001 sends the downlink data to the processor 1010 for processing, and sends uplink data to the base station. Generally, the radio frequency unit 1001 includes but is not limited to an antenna, at least one amplifier, a transceiver, a coupler, a low noise amplifier, a duplexer, and the like.

The memory 1009 may be configured to store a software program or an instruction and various data. The memory 1009 may mainly include a program or instruction storage area and a data storage area. The program or instruction storage area may store an operating system, and an application or an instruction required by at least one function (for example, a sound playing function or an image playing function). In addition, the memory 1009 may include a high-speed random access memory, and may further include a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory, for example, at least one disk storage device, a flash memory device, or another non-volatile solid-state storage device.

The processor 1010 may include one or more processing units. Optionally, an application processor and a modem processor may be integrated into the processor 1010. The application processor mainly processes an operating system, a user interface, an application, an instruction, or the like. The modem processor mainly processes wireless communication, for example, a baseband processor. It can be understood that, alternatively, the modem processor may not be integrated into the processor 1010.

The processor 1010 is configured to determine, based on at least two pieces of uplink control information (UCI), at least one physical uplink control channel (PUCCH) cell corresponding to the at least two pieces of UCI; and
the radio frequency unit 1001 is configured to transmit first target UCI on a target PUCCH cell among the at least one PUCCH cell, where the first target UCI is determined based on the at least two pieces of UCI.

Optionally, the UCI includes at least one of the following:
a hybrid automatic repeat request acknowledgement (HARQ-ACK);
a scheduling request (SR); and
channel state information (CSI).

Optionally, in a case that the at least two pieces of UCI include a first dynamic scheduling HARQ-ACK, the at least one PUCCH cell includes a PUCCH cell corresponding to the first dynamic scheduling HARQ-ACK, and the first dynamic scheduling HARQ-ACK is indicated by a first type of DCI;
in a case that the at least two pieces of UCI include a second dynamic scheduling HARQ-ACK and at least one third dynamic scheduling HARQ-ACK, the at least one PUCCH cell includes a PUCCH cell corresponding to the third dynamic scheduling HARQ-ACK, the second dynamic scheduling HARQ-ACK is indicated by a second type of DCI, the third dynamic scheduling HARQ-ACK is indicated by the first type of DCI, and the second dynamic scheduling HARQ-ACK and the at least one third dynamic scheduling HARQ-ACK are transmitted in a same HARQ-ACK codebook;
in a case that the at least two pieces of UCI include semi-persistent scheduling (SPS) HARQ-ACK, or the at least two pieces of UCI include a dynamic scheduling HARQ-ACK indicated by the second type of DCI, and the dynamic scheduling HARQ-ACK indicated by the second type of DCI is not transmitted, in a same HARQ-ACK codebook, with any dynamic scheduling HARQ-ACK indicated by the first type of DCI, the at least one PUCCH cell includes a PUCCH cell configured according to a protocol or based on higher layer signaling;
in a case that the at least two pieces of UCI include SPS HARQ-ACK, the at least one PUCCH cell includes a PUCCH cell dynamically indicated by SPS activation or reactivation DCI;
in a case that the at least two pieces of UCI include an SR corresponding to one SR configuration, the at least one PUCCH cell includes a PUCCH cell corresponding to first PUCCH transmission, where the first PUCCH transmission is PUCCH transmission corresponding to a scheduling request resource configuration associated with one SR configuration;
in a case that the at least two pieces of UCI include periodic CSI, the at least one PUCCH cell includes a PUCCH cell configured with a first CSI reporting configuration, where the first CSI reporting configuration is a CSI reporting configuration corresponding to the periodic CSI carried on PUCCH; and
in a case that the at least two pieces of UCI include semi-persistent CSI, the at least one PUCCH cell includes a PUCCH cell configured with a second CSI reporting configuration, where the second CSI reporting configuration is a CSI reporting configuration corresponding to the semi-persistent CSI carried on PUCCH.

Optionally, overlapping in time domain exists among PUCCH resources carrying the at least two pieces of UCI, and the PUCCH resources carrying the at least two pieces of UCI are located in at least two PUCCH cells; and
the target PUCCH cell is one of the at least two PUCCH cells, and the first target UCI is determined based on the at least two pieces of UCI.

Optionally, overlapping in time domain exists among PUCCH resources carrying the at least two pieces of UCI, and the PUCCH resources carrying the at least two pieces of UCI are located in at least two PUCCH cells; and
the radio frequency unit 1001 is further configured to: in a period with the overlapping in time domain, transmit the at least two pieces of UCI simultaneously on the at least two PUCCH cells.

Optionally, the first target UCI is determined according to a first preset rule based on the at least two pieces of UCI, and an attribute and a time domain overlapping situation of a PUCCH resource corresponding to each of the at least two pieces of UCI; and
the target PUCCH cell is a PUCCH cell corresponding to a PUCCH resource carrying the first target UCI.

Optionally, the first target UCI includes one of the following:
fusion information obtained by fusing the at least two pieces of UCI; and
a part of UCI selected from the at least two pieces of UCI.

Optionally, the fusion information is determined in any one of the following manners:
as for each of the at least two PUCCH cells, determining first UCI corresponding to each PUCCH cell, and cascading, according to a second preset rule, the first UCI corresponding to each PUCCH cell end to end, to obtain the fusion information; and
determining, based on the at least two pieces of UCI, M classes of UCI to be transmitted, as for a first UCI class among the M classes of UCI, cascading, according to the second preset rule, second UCI corresponding to each first PUCCH cell end to end, to obtain third UCI corresponding to the first UCI class, and cascading, according to a third preset rule, third UCI corresponding to each UCI class end to end, to obtain the fusion information, where the UCI class includes a UCI information type or a UCI transmission requirement, M is an integer greater than or equal to 1, the first UCI class is any UCI class among the M classes of UCI, the first PUCCH cell is any one of PUCCH cell with second target UCI from the at least two PUCCH cells, and the second target UCI includes at least one piece of UCI corresponding to the first UCI class; and the second UCI corresponding to the first PUCCH cell is determined based on the first target UCI corresponding to the first PUCCH cell.

Optionally, the first UCI corresponding to the PUCCH cell is determined in the following manners:
in a case that the number of pieces of UCI corresponding to the PUCCH cell is equal to 1, determining the first UCI corresponding to the PUCCH cell as the UCI corresponding to the PUCCH cell; and
in a case that the number of pieces of UCI corresponding to the PUCCH cell is greater than 1, determining the first UCI corresponding to the PUCCH cell based on the UCI corresponding to the PUCCH cell and according to a first preset rule.

Optionally, in a case that the number of pieces of UCI corresponding to the first PUCCH cell is equal to 1, second UCI corresponding to the first PUCCH cell is the UCI corresponding to the first PUCCH cell; and in a case that the number of pieces of UCI corresponding to the first PUCCH cell is greater than 1, the second UCI corresponding to the first PUCCH cell is obtained based on the UCI corresponding to the first PUCCH cell and according to a fourth preset rule.

Optionally, the part of UCI includes any one of the following:
UCI that is among the at least two pieces of UCI and that is corresponding to a second PUCCH cell among the at least two PUCCH cells;
UCI corresponding to a target type among the at least two pieces of UCI; and
UCI with a target transmission requirement among the at least two pieces of UCI.

Optionally, the second PUCCH cell includes any one of the following:
a PUCCH cell with a maximum index value among the at least two PUCCH cells;
a PUCCH cell with a minimum index value among the at least two PUCCH cells;
a PUCCH cell with an index value being a preset index value among the at least two PUCCH cells;
a PUCCH cell selected from the at least two PUCCH cells based on a physical layer priority corresponding to each of the at least two pieces of UCI;
a PUCCH cell selected based on a cell priority configured for each of the at least two PUCCH cells; and
a PUCCH cell selected based on resource availability information for each of the at least two PUCCH cells.

Optionally, the target PUCCH cell includes any one of the following:
a PUCCH cell selected from the at least two PUCCH cells based on an index value;
a PUCCH cell selected from the at least two PUCCH cells based on a physical layer priority corresponding to each of the at least two pieces of UCI;
a PUCCH cell selected based on a cell priority configured for each of the at least two PUCCH cells;
a PUCCH cell selected based on resource availability information for each of the at least two PUCCH cells;
a second PUCCH cell among the at least two PUCCH cells, where the first target UCI includes a part of or all of UCI corresponding to the second PUCCH cell; and
a third PUCCH cell among the at least two PUCCH cells, where the third PUCCH cell is a PUCCH cell on which a codebook corresponding to a dynamic scheduling HARQ-ACK needs to be transmitted.

Optionally, the radio frequency unit 1001 is further configured to receive resource configuration information of UCI.

Optionally, the resource configuration information includes at least one of the following:
association information between an SR configuration and a scheduling request resource configuration configured on at least one bandwidth part (BWP) of one PUCCH cell;
association information between an SR configuration and a scheduling request resource configuration configured on at least one BWP of N PUCCH cells, where N is an integer greater than 1; and
a CSI reporting configuration configured on a PUCCH cell where corresponding CSI is transmitted.

Optionally, in a case that a same SR configuration included in the resource configuration information is associated with at least two scheduling request resource configurations:
a period and an offset for each of the at least two scheduling request resource configurations are uniformly configured based on a reference subcarrier spacing or a reference numerology; or
a first scheduling request resource configuration among the at least two scheduling request resource configurations is configured based on target information, where the first scheduling request resource configuration is any one of the at least two scheduling request resource configurations, and the target information is a subcarrier spacing or a numerology corresponding to a PUCCH cell and an uplink (UL) BWP in which the first scheduling request resource configuration is located.

Optionally, a fourth PUCCH cell is a PUCCH cell corresponding to a second scheduling request resource configuration, and the second scheduling request resource configuration is any one of the at least two scheduling request resource configurations; and
in a case that a single time unit determined based on the reference subcarrier spacing or the reference numerology corresponds to a plurality of time units on the fourth PUCCH cell, a target time unit is selected from the plurality of time units according to a fifth preset rule, to determine an SR PUCCH resource corresponding to the second scheduling request resource configuration.

Optionally, the target time unit includes one of the following:
a time unit that is able to accommodate the SR PUCCH resource among the plurality of time units;
an earliest time unit that is able to accommodate the SR PUCCH resource among the plurality of time units;
a first time unit among the plurality of time units;
a last time unit among the plurality of time units; and
a time unit corresponding to a first specified index among the plurality of time units.

The terminal 1000 provided in the foregoing embodiment can implement processes implemented in the method embodiment of FIG. 2, and a same technical effect is achieved. To avoid repetition, details are not described herein again.

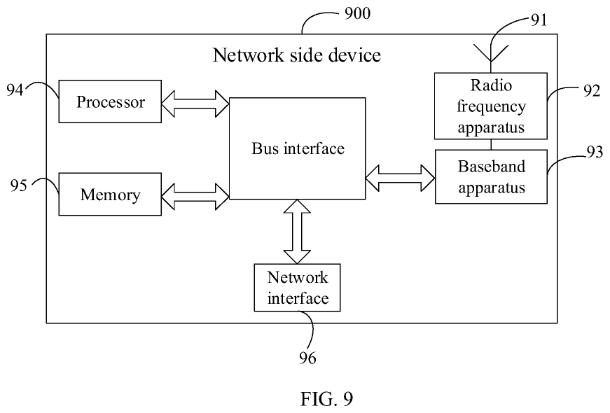

Specifically, an embodiment of this application further provides a network side device. As shown in FIG. 9, a network device 900 includes an antenna 91, a radio frequency apparatus 92, and a baseband apparatus 93. The antenna 91 is connected to the radio frequency apparatus 92. In an uplink direction, the radio frequency apparatus 92 receives information by using the antenna 91, and sends the received information to the baseband apparatus 93 for processing. In a downlink direction, the baseband apparatus 93 processes to-be-sent information, and sends the information to the radio frequency apparatus 92. The radio frequency apparatus 92 processes the received information and then sends the information by using the antenna 91.

The frequency band processing apparatus may be located in the baseband apparatus 93. The method performed by the network side device in the foregoing embodiment may be implemented in the baseband apparatus 93. The baseband apparatus 93 includes a processor 94 and a memory 95.

The baseband apparatus 93 may include, for example, at least one baseband board, where a plurality of chips are disposed on the baseband board. As shown in FIG. 9, one chip is, for example, the processor 94, which is connected to the memory 95, so as to invoke a program in the memory 95 to perform operations of the network device shown in the foregoing method embodiment.

The baseband apparatus 93 may further include a network interface 96, configured to exchange information with the radio frequency apparatus 92. For example, the interface is a common public radio interface (common public radio interface, CPRI for short).

Specifically, the network side device in this embodiment of the present invention further includes an instruction or a program that is stored in the memory 95 and that can be run on the processor 94. The processor 94 invokes the instruction or the program in the memory 95 to perform the method performed by the modules shown in FIG. 6, and a same technical effect is achieved. To avoid repetition, details are not described herein again.

An embodiment of this application further provides a readable storage medium. A program or an instruction is stored in the readable storage medium. When the program or the instruction is executed by a processor, each process of the method embodiment in FIG. 2 or FIG. 4 can be implemented, and a same technical effect can be achieved. To avoid repetition, details are not described herein.

The processor is a processor in the terminal or the network side device in the foregoing embodiment. The readable storage medium includes a computer-readable storage medium, such as a computer read-only memory (ROM), a random access memory (RAM), a magnetic disk, or an optical disc.

An embodiment of this application further provides a chip. The chip includes a processor and a communications interface. The communications interface is coupled to the processor, and when the processor is configured to run a program or instructions of a network side device, each process of the method embodiment in FIG. 2 or FIG. 4 is implemented, and a same technical effect is achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially, or the part contributing to the prior art may be implemented in a form of a software product. The computer software product is stored in a storage medium (for example, a ROM/RAM, a magnetic disk, or a compact disc), and includes several instructions for instructing a terminal (which may be a mobile phone, a computer, a server, an air conditioner, a network, or the like) to perform the method described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. An uplink control information transmission method, comprising:
determining, by a terminal based on at least two pieces of uplink control information (UCI), at least one physical uplink control channel (PUCCH) cell corresponding to the at least two pieces of UCI, the UCI comprising a hybrid automatic repeat request acknowledgement (HARQ-ACK); and
transmitting, by the terminal, first target UCI on a target PUCCH cell among the at least one PUCCH cell, wherein the first target UCI is determined based on the at least two pieces of UCI.

2. The method according to claim 1, wherein the determining, by a terminal based on at least two pieces of uplink control information (UCI), at least one physical uplink control channel (PUCCH) cell corresponding to the at least two pieces of UCI, comprises:
determining, by a terminal based on at least two pieces of UCI, one PUCCH cell corresponding to the at least two pieces of UCI, wherein the one PUCCH cell is the target PUCCH cell.

3. The method according to claim 1, wherein in a case that the at least two pieces of UCI comprise a first dynamic scheduling HARQ-ACK, the at least one PUCCH cell comprises a PUCCH cell corresponding to the first dynamic scheduling HARQ-ACK, and the first dynamic scheduling HARQ-ACK is indicated by a first type of DCI.

4. The method according to claim 3, wherein the first type of DCI comprises an indicator field for indicating the PUCCH cell corresponding to the first dynamic scheduling HARQ-ACK.

5. The method according to claim 4, wherein the PUCCH cells indicated in the first type of DCI corresponding to the same slot or sub-slot are consistent.

6. The method according to claim 1, wherein in a case that the at least two pieces of UCI comprise semi-persistent scheduling (SPS) HARQ-ACK, the at least one PUCCH cell is fixed as a primary cell PCell or PSCell or PUCCH SCell.

7. The method according to claim 1, wherein in a case that the at least two pieces of UCI comprise a dynamic scheduling HARQ-ACK indicated by the second type of DCI, the at least one PUCCH cell is fixed as the primary cell PCell or PSCell or PUCCH SCell, and the second type of DCI does not comprise indicator field for indicating the PUCCH cell corresponding to the first dynamic scheduling HARQ-ACK.

8. The method according to claim 7, wherein in a case that the at least two pieces of UCI comprise a dynamic scheduling HARQ-ACK indicated by the second type of DCI, and the dynamic scheduling HARQ-ACK indicated by the second type of DCI is not transmitted, in a same HARQ-ACK codebook, with any dynamic scheduling HARQ-ACK indicated by the first type of DCI, the at least one PUCCH cell is fixed as the primary cell PCell or PSCell or PUCCH SCell.

9. The method according to claim 1, wherein before the determining, by a terminal based on at least two pieces of UCI, at least one PUCCH cell corresponding to the at least two pieces of UCI, the method further comprises:
receiving resource configuration information for UCI;
wherein the resource configuration information comprises at least one of the following:
association information between an SR configuration and a scheduling request resource configuration configured on at least one bandwidth part (BWP) of one PUCCH cell;
association information between an SR configuration and a scheduling request resource configuration configured on at least one BWP of N PUCCH cells, wherein N is an integer greater than 1; and
a CSI reporting configuration configured on a PUCCH cell where corresponding CSI is transmitted.

10. An uplink control information transmission method, comprising:
receiving, by a network side device, first target UCI transmitted by a terminal through a target physical uplink control channel (PUCCH) cell, the UCI comprising a hybrid automatic repeat request acknowledgement (HARQ-ACK), wherein
the target PUCCH cell is a cell in at least one PUCCH cell, the at least one PUCCH cell is determined based on at least two pieces of uplink control information (UCI), and the first target UCI is determined based on the at least two pieces of UCI.

11. The method according to claim 10, wherein the at least one PUCCH cell is determined based on at least two pieces of uplink control information (UCI) comprises:
one PUCCH cell, corresponding to at least two pieces of UCI, is determined based on at least two pieces of UCI, wherein the one PUCCH cell is the target PUCCH cell.

12. The method according to claim 10, wherein in a case that the at least two pieces of UCI comprise a first dynamic scheduling HARQ-ACK, the at least one PUCCH cell comprises a PUCCH cell corresponding to the first dynamic scheduling HARQ-ACK, and the first dynamic scheduling HARQ-ACK is indicated by a first type of DCI.

13. The method according to claim 12, wherein the first type of DCI comprises an indicator field for indicating the PUCCH cell corresponding to the first dynamic scheduling HARQ-ACK.

14. The method according to claim 13, wherein the PUCCH cells indicated in the first type of DCI corresponding to the same slot or sub-slot are consistent.

15. The method according to claim 10, wherein
in a case that the at least two pieces of UCI comprise semi-persistent scheduling (SPS) HARQ-ACK, the at least one PUCCH cell is fixed as the primary cell PCell or PSCell or PUCCH SCell.

16. The method according to claim 10, wherein in a case that the at least two pieces of UCI comprise a dynamic scheduling HARQ-ACK indicated by the second type of DCI, the at least one PUCCH cell is fixed as the primary cell PCell or PSCell or PUCCH SCell, and the second type of DCI does not comprise the indicator field for indicating the PUCCH cell corresponding to the first dynamic scheduling HARQ-ACK.

17. The method according to claim 16, wherein in a case that the at least two pieces of UCI comprise a dynamic scheduling HARQ-ACK indicated by the second type of DCI, and the dynamic scheduling HARQ-ACK indicated by the second type of DCI is not transmitted, in a same HARQ-ACK codebook, with any dynamic scheduling HARQ-ACK indicated by the first type of DCI, the at least one PUCCH cell is fixed as the primary cell PCell or PSCell or PUCCH SCell.

18. The method according to claim 10, wherein the method further comprises:
sending resource configuration information of UCI;
wherein the resource configuration information comprises at least one of the following:
association information between an SR configuration and a scheduling request resource configuration configured on at least one bandwidth part (BWP) of one PUCCH cell;
association information between an SR configuration and a scheduling request resource configuration configured on at least one BWP of N PUCCH cells, wherein N is an integer greater than 1; and
a CSI reporting configuration configured on a PUCCH cell where corresponding CSI is transmitted.

19. A terminal, comprising a processor, a memory, and a program or an instruction stored in the memory and executable on the processor, wherein the program or instruction, when executed by the processor, causes the processor to perform:
determining, based on at least two pieces of uplink control information (UCI), at least one physical uplink control channel (PUCCH) cell corresponding to the at least two pieces of UCI; and
transmitting first target UCI on a target PUCCH cell among the at least one PUCCH cell, wherein the first target UCI is determined based on the at least two pieces of UCI.

20. A network side device, comprising a processor, a memory, and a program or an instruction stored in the memory and executable on the processor, wherein when the program or the instruction is executed by the processor, steps of the uplink control information transmission method according to claim 10 are implemented.
